(19) United States
(12) Patent Application Publication
(10) Pub. No.: US 2004/0133590 A1
(43) Pub. Date: Jul. 8, 2004

(54) Tree data structure with range-specifying keys and associated methods and apparatuses

(76) Inventors: Alex E. Henderson, Hillsborough, CA (US); Laxminarayana Tumuluru, Sunnyvale, CA (US); Monis Rahman, South Windsor, CT (US); Richard D. Trauben, Morgan Hill, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/637,122

(22) Filed: Aug. 8, 2003

Related U.S. Application Data
(60) Provisional application No. 60/402,359, filed on Aug. 8, 2002.

(51) Int. Cl. G06F 17/00

(52) U.S. Cl. 707/102

(57) ABSTRACT

A tree data structure with range-specifying keys and associated methods. In one embodiment, the data structure is a tree that is stored in a machine readable medium. Each key has two values that define a range and has an associated data item that is associated with the range. Various embodiments of processes to search the tree, add ranges and keys to the tree, delete ranges and keys from the tree, and to generally maintain the tree data structure are disclosed.

This application claims the benefit U.S. provisional application No. 60/402,359, entitled “A Tree Data Structure with Range-Specifying Keys and Associated Methods and Apparatuses,” filed on Aug. 8, 2002.

### FIELD OF THE INVENTION

The present disclosure pertains to the field of data structures and associated processes to build, search, and maintain data structures. More particularly, the present disclosure pertains, in part, to a tree data structure having range specifying keys and various associated methods, which may be used in one embodiment to perform network address lookups.

### BACKGROUND OF THE INVENTION

Developing new techniques to store large quantities of data in rapidly searchable data structures is a fundamental challenge of computer science. Indeed, a wide variety of applications require searches of information based on a particular field (or fields) of a data entry. Names, phone numbers, street addresses, device identifiers, personal identification numbers, device addresses, and network addresses are just a few examples of data that is often searched. Therefore, many applications could benefit from new data storage and search techniques.

One prior art data structure is a B-Tree, an example of which is shown in FIG. 1a. A classical B-Tree includes a root node 50 and child nodes 60 and 65. Each node may have a number of keys that are sequentially ordered, and pointers in between and before and after the keys. Each key contains a single key value, and some data is associated with the key. For example, in the B-Tree of FIG. 1a, the first key in the root node 50 has a value of D, and the second key is G, which is sequentially greater than D. To find whether A is present in the B-Tree, a search begins at the root node. Since D is greater than A, a search will not traverse further into the root node, but rather follows a pointer 55 to the node 60. The node 60 is searched sequentially, left to right, and A is found as the first key.

Similarly, if F is sought, starting in the root node 50, D is recognized as less than F and G is recognized as greater than F, so a pointer 57 is followed to node 65, which is sequentially searched to find the matching entry. Such classic B-Trees may be poorly suited in some cases for some applications. In particular, when many key values would have the same lookup value associated with them, the classic B-Tree may consume a large quantity of storage space to represent the data. Techniques to insert and delete nodes from such traditional B-Tree structures are also known.

With respect to network addresses, the need to perform rapid lookups is particularly acute. The ongoing proliferation of the Internet continuously expands the set of network-connected individual devices and sub-networks. Moreover, increasingly bandwidth intensive applications continue to raise levels of network traffic between these devices. Thus, the demands on the classifying and routing hardware which process all this traffic continue to grow.

One of the most challenging aspects of handling the growing number of packets has become route lookup. For example, a thirty-two bit address, as used in version four of the Internet Protocol (IPv4), could potentially identify over four billion different destinations, and this number pales in comparison to the number of potential destinations supported with the one hundred and twenty-eight bit addresses of IPv6. Moreover, in a classless routing protocol, multiple rules may apply to a particular address, further complicating lookup. Typically, the rule with a longest matching (i.e., most specific) prefix is sought to find the most specific routing or classification information.

Various techniques to perform best (longest) matching prefix lookups have been well documented in the literature. Some such techniques include the use of binary tries, path-compressed tries, PATRICIA tries, multi-bit fixed and variable stride tries, and the like. Additional creative ways to provide fast lookups may be useful for network routing, classification, and other applications.

### BRIEF DESCRIPTION OF THE DRAWINGS

The disclosed embodiments are illustrated by way of example and not limitation in the Figures of the accompanying drawings.

FIG. 1a illustrates a prior art B-Tree.

FIG. 1b illustrates one embodiment of a tree data structure with range-specifying keys.

FIG. 1c provides a range diagram to further detail the association of data items to keys for one embodiment.

FIG. 1d provides a range diagram to further detail the range-specifying nature of the keys (and pointers) of the data structure of FIG. 1b according to one embodiment.

FIG. 2 illustrates a basic set of techniques that may be used in one particular embodiment to construct a tree data structure with range-specifying keys.

FIG. 3 illustrates a generalized search technique for a tree data structure with range-specifying keys.

FIG. 4a illustrates one embodiment of a tree data structure for use in performing an address lookup.

FIG. 5a illustrates one embodiment of a search process for a tree data structure.

FIG. 5b illustrates one embodiment of a prefix compare process.

FIG. 6a illustrates one embodiment of a process to add a data item with an associated range to a tree data structure.

FIG. 6b illustrates a first portion of detailed add process according to one embodiment.

FIG. 6c illustrates a second portion of the add process of FIG. 6b according to one embodiment.

FIG. 7a illustrates range diagrams for different longer prefix fragment insert scenarios.

FIG. 7b illustrates a process to handle three of the longer prefix fragment insert scenarios of FIG. 7a.

FIG. 7c illustrates a process to handle the remaining three of the longer prefix fragment insert scenarios of FIG. 7a.

FIG. 7d illustrates one example of a longer prefix fragment insert according to one embodiment.

FIG. 8a illustrates range diagrams for two different shorter prefix fragment insert scenarios according to one embodiment.

FIG. 8b illustrates one embodiment of a process to handle the shorter prefix fragment insert scenarios of FIG. 8a.

FIG. 9a illustrates one embodiment of a first next greater key process according to one embodiment.

FIG. 9b illustrates one embodiment of a second find next greater key process according to one embodiment.

FIG. 10a illustrates range diagrams for two add overlap and fragment cases according to one embodiment.

FIG. 10b illustrates one embodiment of an add overlap and fragment process.

FIG. 11a illustrates a key insert process according to one embodiment.

FIG. 11b illustrates a detailed key insert process according to one embodiment.

FIGS. 11c-11e illustrate an example of a key insertion according to one embodiment.

FIG. 12a illustrates a delete process according to one embodiment.

FIG. 12b illustrates a first portion of a detailed delete process for one embodiment.

FIG. 12c illustrates a second portion of a detailed delete process for one embodiment.

FIG. 13a illustrates a first portion of a replace and adjust process according to one embodiment.

FIG. 13b illustrates a second portion of the replace and adjust process of FIG. 13a according to one embodiment.

FIG. 14 illustrates a key delete process for one embodiment.

FIG. 15a illustrates an adjust underflow process according to one embodiment.

FIG. 15b details a merge or borrow left process according to one embodiment.

FIG. 15c details a merge or borrow right process according to one embodiment.

FIG. 16a illustrates one embodiment of a generalized system to build, use and maintain a tree data structure.

FIG. 16b illustrates another embodiment of a system to build, use and maintain a tree data structure.

FIG. 17 illustrates an embodiment in which a set of software routines implement the various modules to build, use and maintain a tree data structure.

### DETAILED DESCRIPTION OF THE INVENTION

The following description provides a tree data structure with range-specifying keys and associated methods. In the following description, numerous specific details are set forth in order to provide a more thorough understanding of the present invention. It will be appreciated, however, by one skilled in the art, that the invention may be practiced without such specific details.

The present disclosure describes techniques to provide fast lookups that may be useful for both network routing and other applications. For example, these techniques may be used to perform best matched prefix lookups in some embodiments. However, these techniques may be used for a variety of other applications as well. For example, any application in which ranges of values have data associated with them may utilize one or more of the disclosed techniques. Moreover, if multiple data items may be applicable to a particular range, one or more of the disclosed techniques may be used to track the multiple data items, including an order of precedence, if desired. In some of the disclosed embodiments, a best match may be found by traversing only to a first matching key, rather than traversing further to child nodes to search for a better match. Moreover, some embodiments may allow the tree data structure to be used to perform searches and to obtain correct results (i.e., either the valid old result or a valid new result) while updates to the data structure remain in progress.

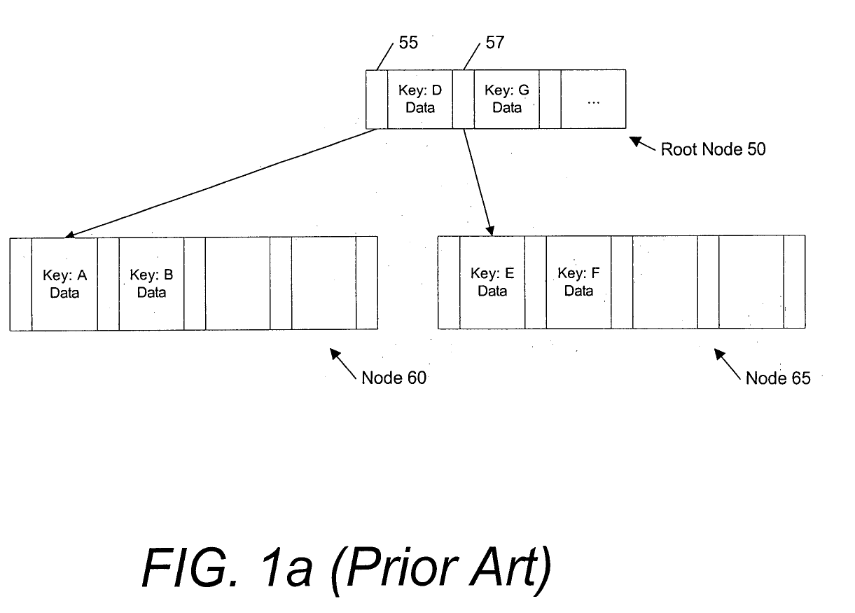

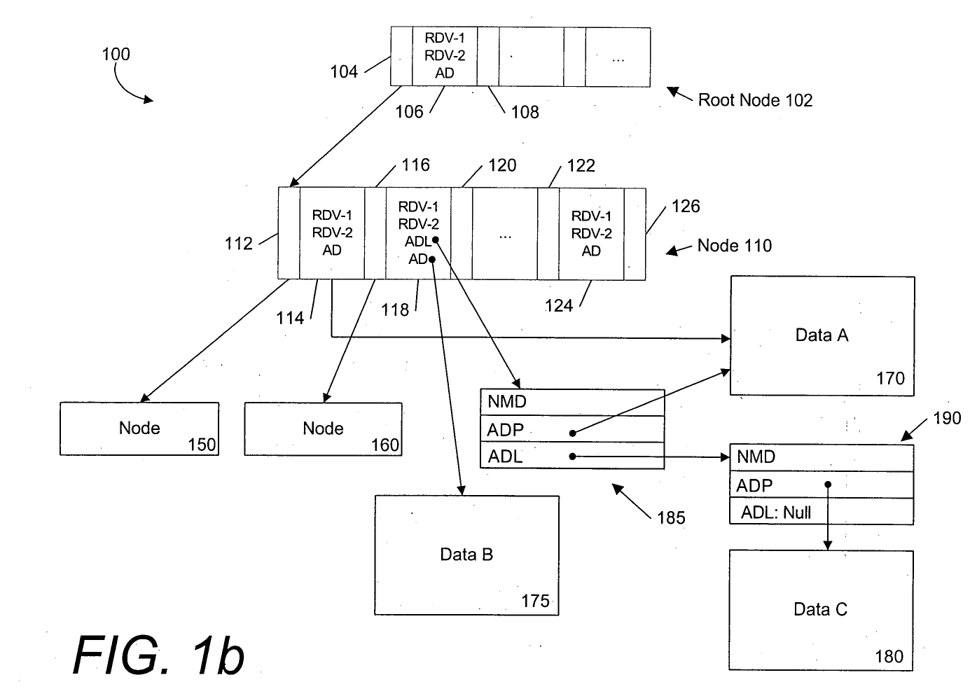

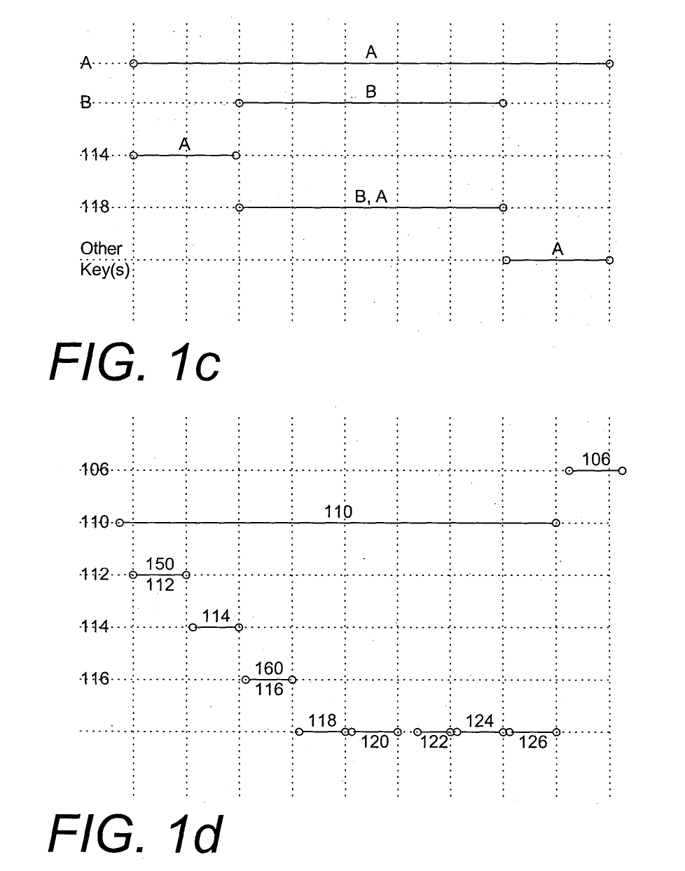

FIG. 1b illustrates one embodiment of a tree data structure 100 with range-specifying keys. The tree structure of FIG. 1b may be referred to as a multiway tree in some cases due to the fact that nodes include multiple keys. In some cases, the tree of FIG. 1b may also be considered or referred to as a B-Tree. A B-Tree is a data structure that has multiple sequentially ordered keys in at least some nodes and in some cases includes child pointers to nodes between key values, or before or after key values for respectively the first and last keys in a node. An additional guideline is that a B-Tree with a maximum of N keys per node may maintain a minimum number of keys in each node, except a root node, to limit tree height. For example, N/2 nodes may be the minimum number in some cases, but other larger or smaller minimums, or no minimum at all, may be used. Additionally, even if a minimum number is generally used, in some embodiments, the tree of FIG. 1b may temporarily include nodes that do not conform to such a minimum key number guideline during update processes. In some embodiments, various disclosed techniques may be used without attempting to maintain a strict B-Tree structure at all.

In the embodiment of FIG. 1b, a root node 102 includes a first pointer 104, a key 106 and a second pointer 108. The key 106 includes a first range defining value (RDV-1) and a second range defining value (RDV-2). The first and second range defining values define a range (also referred to as a span). In one embodiment, the range defining values may be a lower bound and an upper bound, but in other embodiments other techniques may be used to define the range for the key 106. One of skill in the art will recognize that a range for a key may be defined in numerous ways, with two or more values. For example, a range midpoint and length may be used to define the range. Similarly, a range endpoint and length may be used to define the range. Ranges may be defined to be inclusive or exclusive of endpoint values. Additionally, a “range” typically implies multiple values; however, in some cases, a “range” may actually be a single value according to disclosed techniques. For example, a lower bound and upper bound may be set to the same value, making the range include only that single value.

The key 106 also includes an associated data (AD). The AD may be any data pertinent to the range defined by the range defining values. Therefore, the AD may contain a data item to be returned in response to search for a value falling within the ranged defined by the range defining values. The AD may be a pointer to the data item, a pointer to a data structure that stores the data item, or the AD may include or be the data item for embodiments in which the key stores the data item with the key.

The pointer 104 points to a child node 110. In this embodiment, the node 110 itself has capacity to store N keys and N+1 pointers. In particular, the node 110 includes a first pointer 112, a first key 114, a second pointer 116, a second key 118, a third pointer 120, an Nth pointer 122, an Nth key 124, and a last pointer 126. In other embodiments, nodes may hold a variable or arbitrary number of keys and/or pointers. In the example of FIG. 1b, the pointer 112 points to a node 150 and the pointer 116 points to a node 160. The node 150 contains keys pertaining to the values within a range beyond the range of key 114. For example, the node 150 may span a range above or below the key 114, depending on whether the tree is arranged according to sequentially increasing or decreasing keys. Similarly, the node 160 covers at least part of the range between the ranges of keys 114 and 118. Thus, keys that represent ranges may be stored sequentially but have gaps between them. For example, a range between keys may not have a defined associated data or may be covered by a pointer.

In the example of FIG. 1b, the key 114 has an associated data pointer pointing to an associated data 170, whereas the key 118 has an associated data pointer pointing to an associated data 175. When a search value is determined to be within a range of defined by the range defining values for a particular key, the associated data for that key or a part of it may be returned. No further traversal to other keys or nodes may be necessary once a matching key is found.

The key 118 also has an AD link (ADL) pointer pointing to a next matching data (NMD) data structure 185. The NMD data structure 185 has an AD pointer to the associated data 170 and an AD link pointer pointing to another NMD data structure 190. The NMD data structures allow a linked list of values to be maintained for a particular range. For example, the “best” value (i.e., the default value to be returned for a hit to that key range) may be stored via the associated data for that key. However, other previous values or less important values may be stored via linked list. Thus, the associated data 170 may be a second choice for a hit to the range defined by the key 118. Similarly, the second NMD data structure 190 has an associated data pointer pointing to another associated data 180. The associated data 180 may be a third choice for a hit to the range defined by the key 118. Additionally, maintaining a list of subservient or lower priority or precedence data items may facilitate deletion of the primary data item. In other words, if associated data 175 needs to be deleted, the key 118 still has a link to the subservient data items which may move up in precedence in response to deletion of the associated data 175. In this embodiment, a prioritized (ordered) linked list is effectively formed to track multiple data items for each range. In other embodiments, other data structures and/or prioritized data structures may be used to store multiple data items associated with each key if desired. For example, an array, a tree, a hash table, or some combination of these and/or other known or otherwise available data structures may be used to prioritize data associated with each key.

FIG. 1c provides a range (span) diagram to further detail the association of data items to keys for one embodiment. Each horizontal line in FIG. 1c represents a range of values. A first line, labeled “A” corresponds to associated data 170. The data item A applies to a large range, as indicated by the relatively long line. The second line, “B”, corresponds to associated data 175. The data item B applies to a shorter range than A, and the range for data item B is contained within the range for data item A. Since there are two overlapping data items within this range, a single key is not used to represent the entire range. Rather, the keys 114, 118 and one or more additional keys are all used to represent the range for data item A.

Thus, as indicated by the line labeled, 114, the key 114 covers a range from the lower bound of the range associated with data item A up to the lower bound of the range associated with data item B. Therefore the associated data for key 114 points to the associated data 170. The key 118 has two associated data items, A and B, and covers the range including the lower bound to the upper bound of the range associated with data item B. For the purposes of this example, it is assumed that the more specific, (i.e., smaller range) data item B takes precedence. Therefore, the associated data for the key 118 points to the associated data 175. Furthermore, the associated data link for the key 118 points to the NMD data structure which points to the associated data 170. Therefore, a linked list sorted by order of precedence (B, A) is associated with the range for the key 118 as indicated in FIG. 1c. Additionally, data item C from associated data 180 may also be included as the lowest precedence data item; however, C may apply to the other segments as well and therefore is omitted in FIG. 1c for clarity.

Finally, there is an additional portion of the range for data item A above the range for data item B. If no more data items overlap this range, a single key may be used to represent this fragment of A. If other overlapping data items exist, then further fragmentation and therefore multiple keys may be needed to represent the remaining portion of the range for data item A. Thus, multiple non-overlapping ranges may be represented by the data structure, and multiple ordered data items may be maintained per range in some embodiments.

FIG. 1d provides a range diagram to further detail one example of non-overlapping and range-specifying keys (and pointers) in the data structure of FIG. 1b. Numbers above each line correspond to an associated node or key and numbers below each line correspond to a pointer. The line labeled 106 corresponds to a range for the root node key 106, whereas the line labeled 110 corresponds to a range for the node 110. For simplicity of discussion, the tree is assumed to progress from smaller to larger values moving from left to right and top to bottom, and the values in the range diagram will be assumed to increase from left to right; however, one of skill in the art will readily recognize that another embodiment can progress from larger to smaller values in traversing from left to right and/or top to bottom of the tree data structure.

The range for the root node key 106 is greater than and non-overlapping with respect to the range for node 110. Therefore, line 106 is shown to the right of line 110 and correspondingly the node 110 is pointed to by a pointer to the left of the key 106. Any pointers or keys to the right of key 106 are greater than an upper bound of the key 106. In this example, ranges are defined to be inclusive of a lower bound and an upper bound.

The node 110 includes on its far left an end pointer, pointer 112. The pointer 112 includes the lowest range covered by node 110. In this case, the node 110 does not include keys that correspond to the range covered by pointer 112, but rather node 150 or its child nodes include such keys. The pointer 112 may not itself include explicit range defining values. Rather, the pointer may rely on the range defined by an adjacent key. Notably, a key (or pointer) is “adjacent” to another key or pointer if it is in a same node and is defined or indicated by the data structure to be adjacent. Adjacent items may or may not have adjacent memory addresses.

The key 114 spans a range as indicated by the line marked 114 in FIG. 1d. The lower bound of the key 114 may define a cutoff for the pointer 112. In other words, if a value is below the lower bound of key 114, then the pointer 112 is traversed to find a key for that value. The upper bound of key 114 is also defined by the range defining values of the key 114.

An inner pointer, such as pointer 116, falls between two adjacent keys. The lower bound of the key 118 and the upper bound of the key 114 define the range for the pointer 116. Therefore, any value that falls between the keys 114 and 118 may result in traversing to node 160 as pointed to by the pointer 116. Thus, a line 116 indicates a range for the pointer 116 which is non-overlapping with respect to the lines for keys 114 and 118. While node 160 may not contain data for this range in all cases, whether or not it does is indeterminate from the information in the node 110. Therefore, node 160 is searched if the pointer is not null. Similarly, the lines, and correspondingly the ranges, for pointers 120 and 122, key 124, and pointer 126 are sequentially ordered by range values and non-overlapping with respect to each other. A gap is shown between the lines for pointers 120 and 122 because, as indicated by the ellipses in FIG. 1b, one or more keys and/or pointers may fall between pointers 120 and 122.

The various nodes, pointers and keys described herein may be stored or represented in variety of manners. The nodes may themselves be data structures stored in a variety of known or otherwise available manners. For example, in one embodiment, a node may be stored in contiguous memory locations in a storage device such as a register or a memory much as displayed in FIG. 1b. Such nodes may be aligned with particular memory boundaries in some embodiments. In another embodiment, on a node basis or otherwise, keys may be grouped and stored contiguously and pointers may be separately grouped and stored contiguously, as may be useful to align data structures to memory boundaries. In another embodiment, keys and/or pointers may be spaced at predetermined intervals as may be advantageous to allow use of efficient memory access techniques or for other reasons. Additionally, in some embodiments, the keys and pointers may not be structured in particular fashion with respect to memory addresses. Rather, keys and pointers may themselves be arranged in any convenient data structure or a non-structured arrangement, so long as “adjacent” keys and pointers (i.e., keys and pointers representing next less and next greater spans) can be identified such that the tree is at least logically assembled when the nodes are processed.

Moreover, the various data structures and data items may be stored in any type of machine readable medium. A machine readable medium may be a storage device such as a memory device, a magnetic or optical disk, or may be a carrier medium which itself stores or carries data which is encoded, modulated or otherwise transmitted.

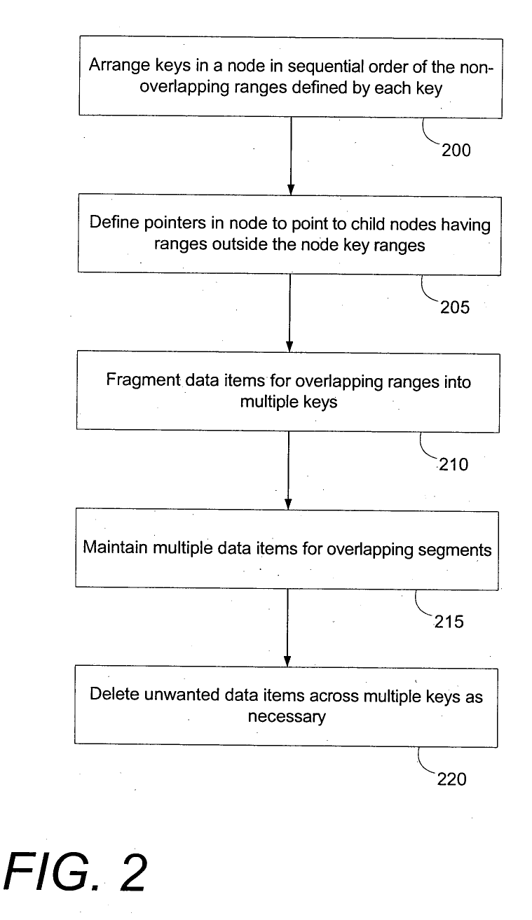

FIG. 2 illustrates a basic set of techniques that may be used in one particular embodiment to construct a tree data structure with range-specifying keys. Throughout this disclosure, and particularly with respect to FIG. 2, flow diagrams or flow charts may not necessarily indicate a strict sequencing. Various operations may be performed in a different order or in parallel in some cases.

As indicated in block 200 of FIG. 2, in a tree structure with range specifying keys, keys are arranged in a node in sequential order of non-overlapping ranges associated with each key. Various techniques to insert a key or a particular range will be further discussed below; however, in general, after completion of the appropriate insertion process, keys are arranged sequentially. Some embodiments advantageously use a multi-step key insertion process to insert new keys such that the data structure remains searchable during the key insertion process. During such processes, overlapping keys may be temporarily created.

As indicated in block 205, child nodes pointed to by pointers in a node are defined to have ranges outside of the keys of the node. Pointers may fall between and before and after the keys in a node. Effectively, the range of the pointer may be considered to be non-overlapping with respect to the keys in the node. As indicated in block 210, data items for overlapping ranges may be fragmented into multiple keys. Various cases of fragmentation may occur, and particular techniques to handle fragmentation will be further discussed below. Additionally, in some embodiments, it may be advantageous to maintain multiple data items for a particular range. Therefore, as indicated in block 215, multiple data items may be maintained per key (i.e., per range) for overlapping ranges. Some embodiments may discard old or lower priority data for a particular range.

Finally, as indicated in block 220, unwanted data items may be deleted from the tree. Various techniques described herein may be used to eliminate the unwanted data items. Deleting data items may result in ranges that should be de-fragmented. Furthermore, deleting data items may require that the tree data structure be re-balanced or otherwise adjusted in some cases if a balanced B-Tree type data structure is desired. Some embodiments employ techniques that allow searching during key deletion, de-fragmentation, and/or re-balancing of the tree.

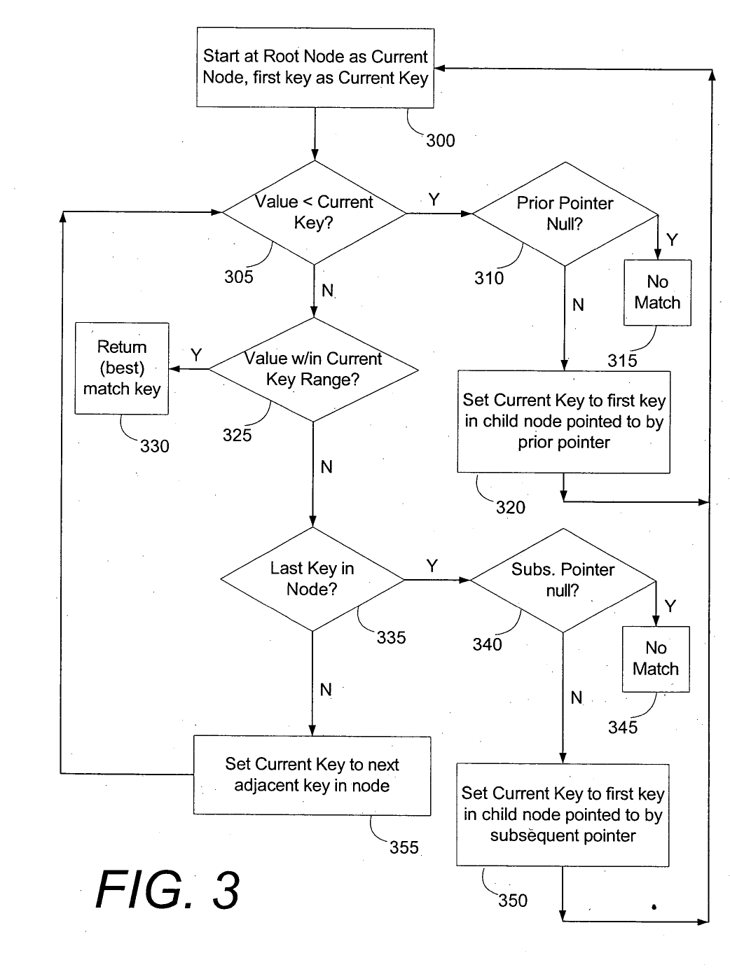

FIG. 3 illustrates a generalized search technique usable for a tree data structure with range-specifying keys. In this embodiment, a data item associated with a value is to be returned if the value is within a key range in the tree data structure. As indicated in block 300, the search begins with the root node as the current node, and the first (e.g., leftmost) key as the current key. In block 305, whether the value is lower than the current key range is tested. If so, a prior pointer is tested as indicated in block 310. If the prior pointer indicates null (i.e., some value indicating that the pointer does not point to another node), then no matching entry is found as indicated in block 315. If the prior pointer does not indicate null, but rather indicates a child node, then the current key is set to the first key in the child node pointed to by the prior pointer as indicated in block 320. The procedure continues back at block 305, operating on the new key in the new node.

If the value is not less than the current key range (as tested in block 305), then whether the value is within the current key range is tested in block 325. If the value is within the current key range, then the matching data item is returned as indicated in block 330. An advantageous feature of one embodiment of the tree data structure with generally non-overlapping, range-specifying keys is that once a match is found, no further traversing of the tree is required because a best match data item for a value may be stored at the first key that will be encountered indicating the range containing the value. A reduction of tree search time may result as compared to other approaches which require full traversal of the tree to a leaf node to determine if better matches are contained elsewhere. Also, as previously noted, some embodiments may store multiple matches for a particular value via a single key, in which case a best matching data item may be returned either automatically or as defined by some secondary criteria besides the value.

If the value is not within the current key range (as tested in block 325), then whether the current key is the last key within the current node is tested as indicated in block 335. If the current key is the last key in the current node, then whether the subsequent (last) pointer is null is tested in block 340. If the last pointer in the current node is null, then no match occurs as indicated in block 345. If, however, the last pointer is not null, then the current key is set to the first key in the child node pointed to by the pointer as indicated in block 350. The procedure continues back at block 305, operating on the new key in the new node.

If, however, the current key is not the last key in the current node (as tested in block 335), then the current key is set to the next adjacent key, and the procedure continues back at block 305, operating on the new key in the same node. In various embodiments, two or more of these compare and null-detect operations may be performed in parallel (e.g., an entire node may be processed simultaneously). Moreover, range comparisons may be performed by comparing the value to an upper and lower bound.

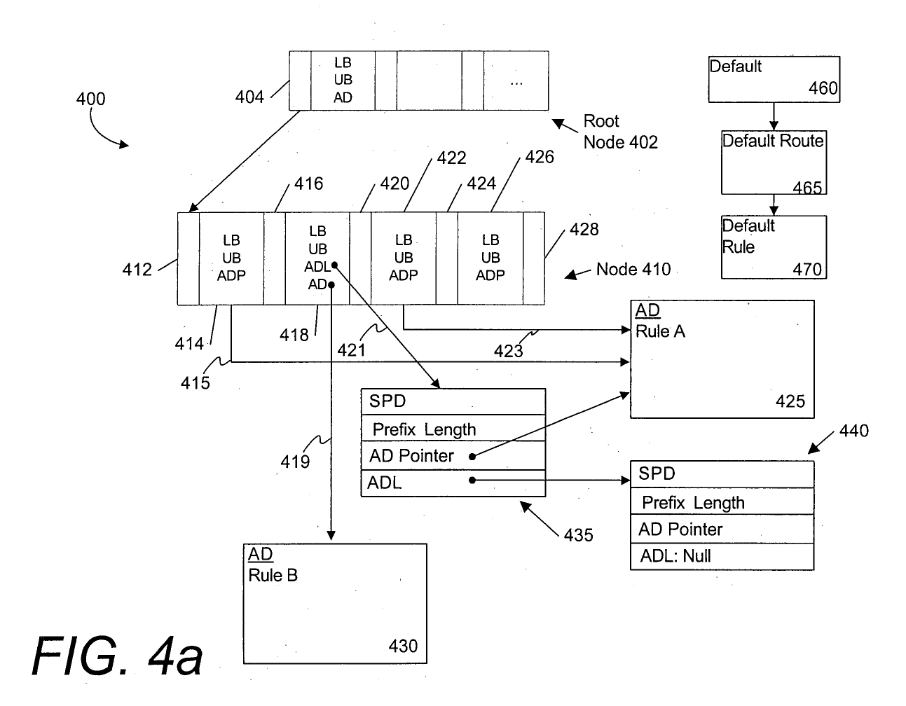

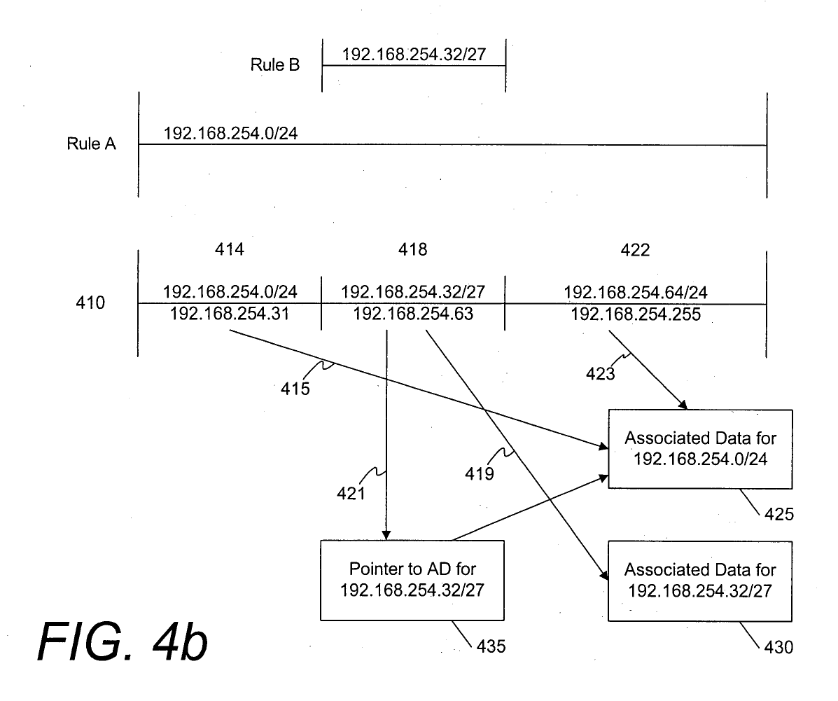

Tree data structures with range-specifying keys may be particularly advantageous in address lookups for classification and/or routing of network packets, and FIG. 4a illustrates one embodiment of a tree data structure usable for address lookups. For example, a network packet may be destined for a particular address. A variety of rules may apply to determine how to classify, route, or sort that packet. For example, various subnet masks may cover a range including the destination address. Typically, a most specific set of subnet information will be applied instead of a less specific set of subnet information. In classless IP-based routing, a variable length prefix may be used to specify the range to which a particular rule applies. A longer prefix indicates a more specific subnet, and therefore is generally considered to be a better match.

Therefore, a particular address being looked up is a value that may be looked up using a tree with range-specifying keys. Different rules associated with different length prefixes may be associated with a particular key, but the longest prefix is generally considered to be the best match, and that is the data often desired to be returned. Thus, the prefix length may be the secondary criteria by which additional data items are sorted for each key. Since IP lookup is an extremely time-sensitive task in some applications, reducing search time through the use of a tree that does not require full root-to-child traversal to find a best match may be quite advantageous.

In the embodiment of FIG. 4a, the data structure 400 includes a root node 402 having a child pointer 404 pointing to a node 410. The node 410 includes four keys 414, 418, 422, and 426 that are sequentially ordered by range. Each key includes a lower bound and an upper bound to define the range for that key, as well as an associated data pointer. The node 410 also includes five pointers 412, 416, 420, 424, and 428. Pointer 412 is a first end pointer to the left of key 414, and pointer 428 is a second end pointer to the right of key 426. Pointers, 416, 420, and 424 are inner pointers between respectively keys 414 and 418, keys 418 and 422, and keys 422 and 426. In this embodiment, each key and pointer defines a non-overlapping range with respect to all other keys and pointers, with the possible exception of a temporary but non-conflicting overlap during tree modification as will be further discussed below. Other embodiments may allow overlap to persist as long as conflicting information is not indicated by different active keys.

In the embodiment of FIG. 4a, the key 414 includes an associated data pointer 415 pointing to an associated data (AD) data structure 425. The AD data structure 425 includes a rule which is applicable to the range defined by the lower and upper bounds of the key 414. The rule may be a classification rule, (e.g., a quality of service or type of data packet associated with the address range), a routing rule (e.g., a next hop), or any type of useful information associated with the addresses within the key range. Multiple items may be stored in the AD data structure. For example, routing information, classification information, prefix length, and status information (e.g., active/inactive), etc., may be stored.

The key 418 includes not only an associated data pointer 419 pointing to an AD data structure 430, but also an associated data link (ADL) 421 pointing to a shorter prefix data (SPD) data structure 435. The SPD data structure 435 includes an associated data pointer and another associated data link. Thus, shorter prefix information can be linked to a key via an ADL and SPD data structure. In the embodiment of FIG. 4a, the SPD data structure 435 stores an ADL to another SPD data structure 440, as well as an AD pointer to the AD data structure 425. Thus, the associated data for the best match prefix for key 418 is stored in the AD data structure 430, and a second best match (i.e., a shorter) prefix is stored in the AD data structure 425. A third best match prefix may be stored in an AD data structure linked to the SPD data structure 440 by the AD pointer of the SPD data structure 440, and additional rules may be linked thereafter as well. However, in the embodiment illustrated, the SPD data structure 440 has a null ADL pointer, indicating that there are no further rules that apply to the range for key 418. Effectively, a linked list of associated data is formed, with the head associated data being pointed to by the AD pointer of the key, and the remainder of the list being pointed to via the ADL pointer and SPD data structures. Finally, the key 422 includes an AD pointer 423 that points to the AD data structure 425. One of skill in the art will appreciate that various different types of linked lists may be used according to generally known or otherwise available techniques. Additionally, other types of data structures and/or prioritized data structures can be used to store multiple associated data associated with a key in other embodiments, as previously discussed.

Additionally, a default entry 460 may be provided in case a miss occurs when searching the tree data structure. A default rule 470 is a lowest precedence rule that is used if a tree miss occurs and no higher priority route information is available. In some cases, a default route 465 may be specified and take higher precedence than the default rule 470. The default entry, rule, and optional route may be stored similarly to other tree structures and/or may be stored independently in a more convenient or accessible fashion.

FIG. 4b provides a range diagram to further detail association of ranges, keys, and pointers to rules for one embodiment. In the example of FIG. 4b, Rule A applies to a range defined by the address 192.168.254.0 and the prefix 24 (represented as 192.168.254.0/24). Rule B applies to the range defined by 192.168.254.32/27. Rule B is more specific because it relates to a subnet or a set of devices specified by a longer prefix. Therefore, Rule B should take precedence in this example. In this example, it is assumed that no pointers extend to child nodes below node 410.

Thus, key 414 has a lower bound of 192.168.254.0 and an upper bound of 192.168.254.31, and the associated data pointer 415 for key 414 points to the AD data structure 425 which contains associated data (Rule A) for 192.168.254.0/24. Key 418 has a lower bound of 192.168.254.32 and an upper bound of 192.168.254.63. AD pointer 419 for key 418 points to the AD data structure 430 which contains associated data (Rule B) for 192.168.254.32/27. Key 418 also has ADL 421 which points to the SPD data structure 435. The SPD data structure 435 points to AD data structure 425 to indicate that a shorter prefix match for key 418 is Rule A, the rule for 192.168.254.0/24.

Accordingly, ranges may be represented by the keys of the tree, and each key may link multiple prefix length rules to a single key. Moreover, pointers may indicate non-overlapping ranges in each node not covered by the keys. This structure may be quite advantageous for searching, adding to, deleting from, and maintaining the tree in some embodiments.

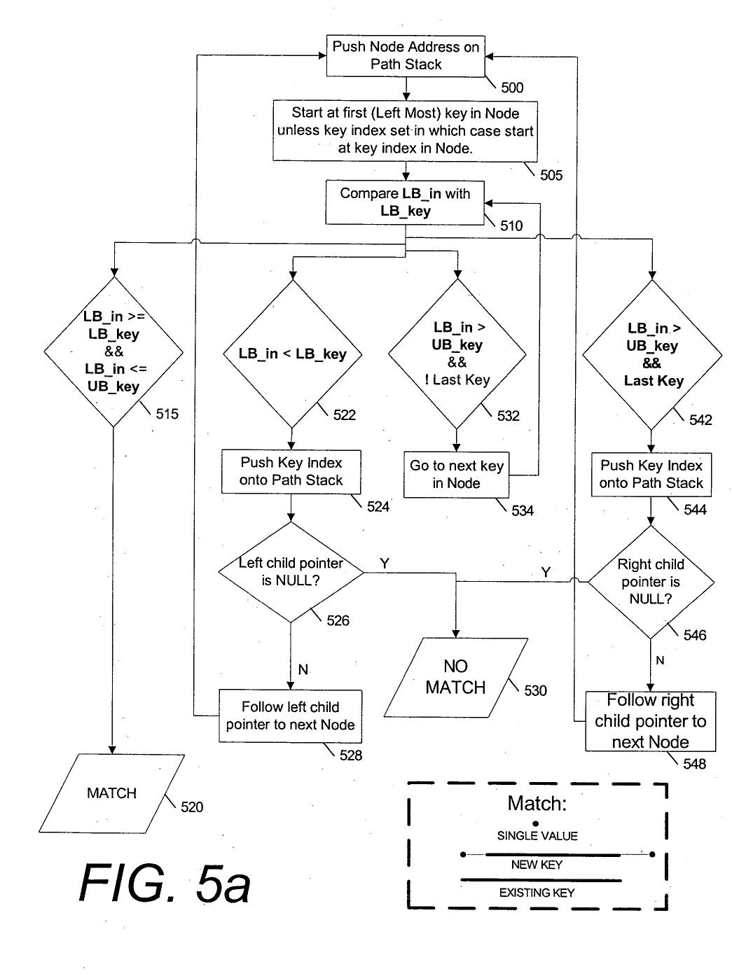

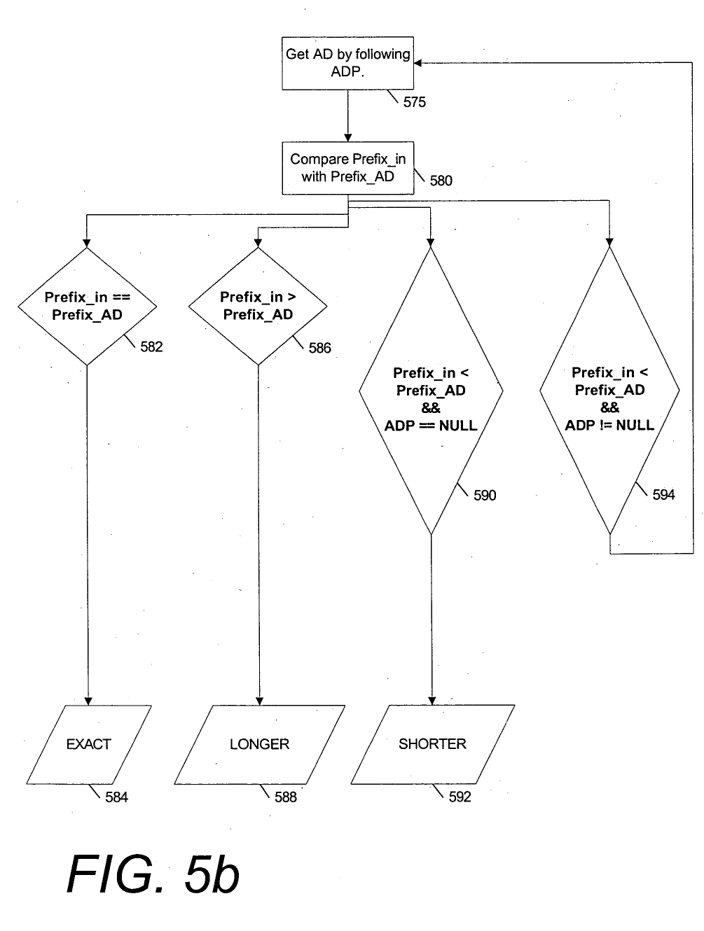

FIG. 5a illustrates one embodiment of a search process for a tree data structure with non-overlapping, range-specifying keys. This particular search process may be used extensively in other processes. In some processes, such as when adding a node or deleting a node, it may be advantageous to track the path traversed to reach the matching node to facilitate management of the tree structure after the insertion or deletion of the node. Therefore, the node address of the current node is pushed on a path stack as indicated in block 500. The value being searched is referred to as the lower bound input (LB_in), as the lower bound of a range is a frequently searched value. As indicated in the block labeled match, a single value (e.g., address) may be searched and matches if it falls within the range of an existing key. A new range may match if its lower bound is within the range of the existing key (and the lower bound is input as the search value).

A key index for a search typically starts off at the leftmost (first) key in the node. As indicated in block 505, unless the key index is set otherwise by another process, the search starts at the leftmost node. Blocks 515, 522, 532, and 542 represent results of comparisons made in block 510 between the lower bound input (LB_in) and the lower bound of the current key (LB_key) and the upper bound of the current key (LB_key). These comparisons may be performed in parallel, sequentially, or in some other order. In fact, these may not be separate comparison operations but rather one comparison of the input value to the current key range with four possible results. Each of these blocks indicates that the particular comparison is true, and one of the four blocks should be true for each value. As indicated in block 515, if the input value is greater than or equal to the current key lower bound and the input value is less than or equal to the current key upper bound, then a match had been found, and the match is indicated in block 520.

In block 522, whether the input value is less than the current key lower bound is tested. If the input value is less than the current key lower bound, then the input value falls to the left of the node. Thus, after the key index is pushed on the path stack as indicated in block 524, whether the left child pointer is null is tested in block 526. If the left child pointer is not null, the search traverses to the next node by following the left child pointer to the next node as indicated in block 528. Thereafter, the search returns to block 500. If the left child pointer is null in block 526, then no match occurs as is indicated in block 530.

In block 532, whether the input value is greater than the upper bound of the current key is tested. If so, then the search traverses to a next key by moving to the next key in the current node as indicated in block 534. Thereafter, the search returns to block 510.

In the case of block 542, the input value is greater than the upper bound of the current key. In this case, the key index is pushed to the path stack as indicated in block 544, and whether the right child pointer is null is tested block 546. If the right child pointer is null, then no match occurs as is indicated in block 530. If, however, the right child pointer is not null, then the search traverses to another node by following the right child pointer to the next node as indicated in block 548. Thereafter, the search returns to block 500.

In the case where a range match is not enough and a prefix compare is also needed, the prefix compare may be performed according to FIG. 5b. Presumably a matching key has been found at this point (e.g., by the search technique of FIG. 5a). As indicated in block 575, the associated data (AD) is retrieved by following the associated data pointer. The input prefix value (Prefix_in) is compared with the prefix in the associated data entry as indicated in block 580. Four cases may result from this comparison. Again, a single comparison may be performed, or parallel or sequential comparisons may be performed.

If the input prefix is equal to the associated data prefix (block 582), then an exact match is found as indicated in block 584. If the input prefix is greater than the associated data prefix (block 586), then the new prefix is a longer prefix as indicated in block 588. If the input prefix is less than the associated data prefix, and the associated data pointer is null as indicated in block 590, then the new prefix is a shorter prefix as indicated in block 592. If the input prefix is less than the associated data prefix and the associated data pointer is not null as indicated in block 594, then the process returns to block 575 to keep traversing until the shortest prefix is found.

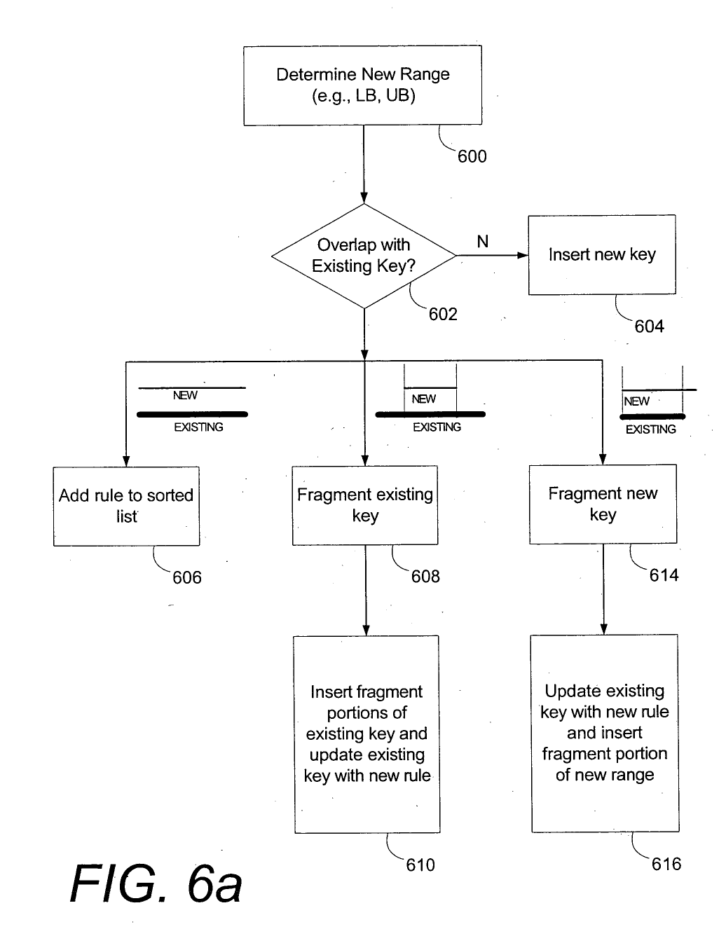

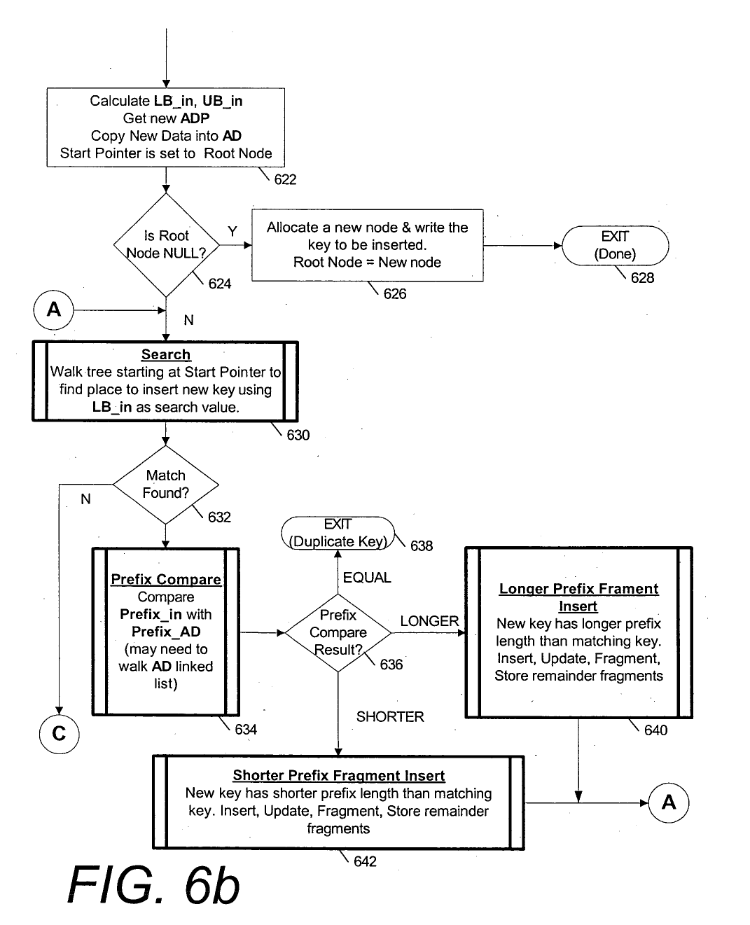

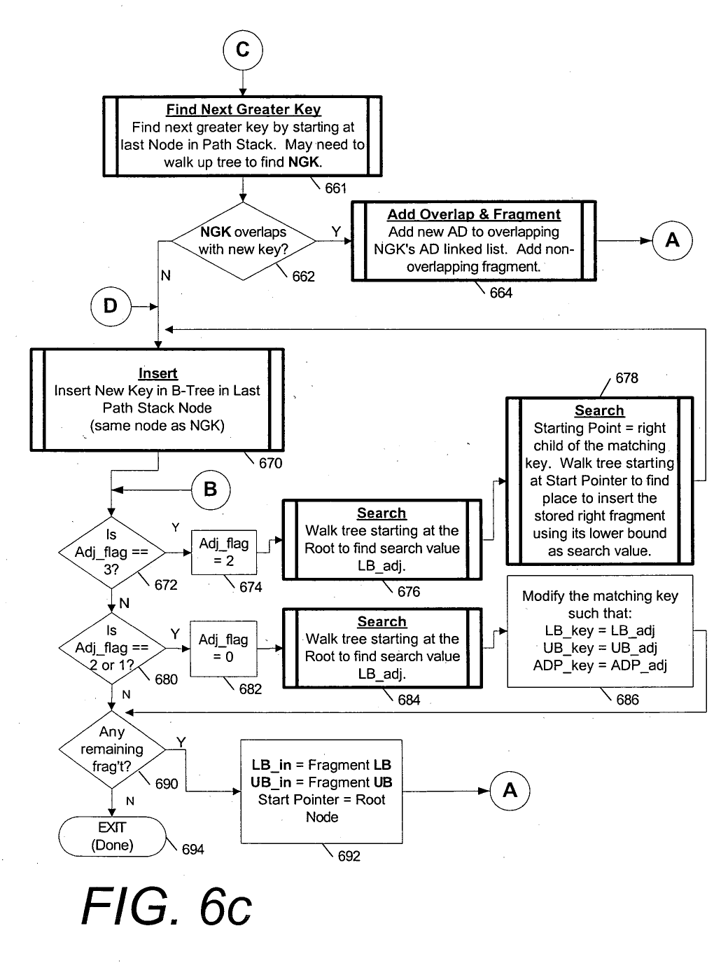

Adding new ranges to a data structure expands the number of lookup operations that can be satisfied; however, adding nodes to a tree, and particularly to a tree that is somewhat or completely balanced may be quite complex. Thus, a simplified flow diagram indicating generally how a new range and an associated rule may be added to the tree is shown in FIG. 6a. As indicated in block 600, a new range is determined for the rule. In one embodiment, the new range may be the address range defined by an address and prefix. The upper bound and lower bound of this range can be computed by conventional techniques.

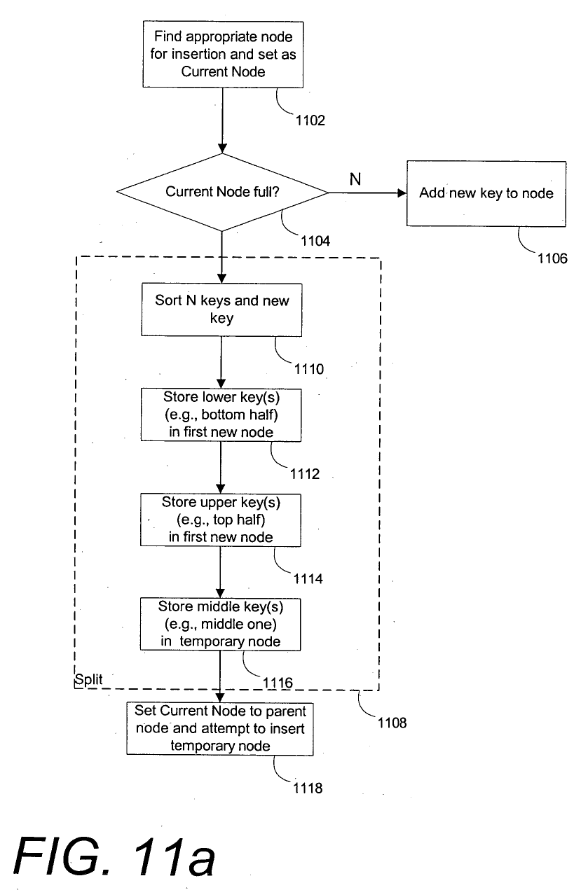

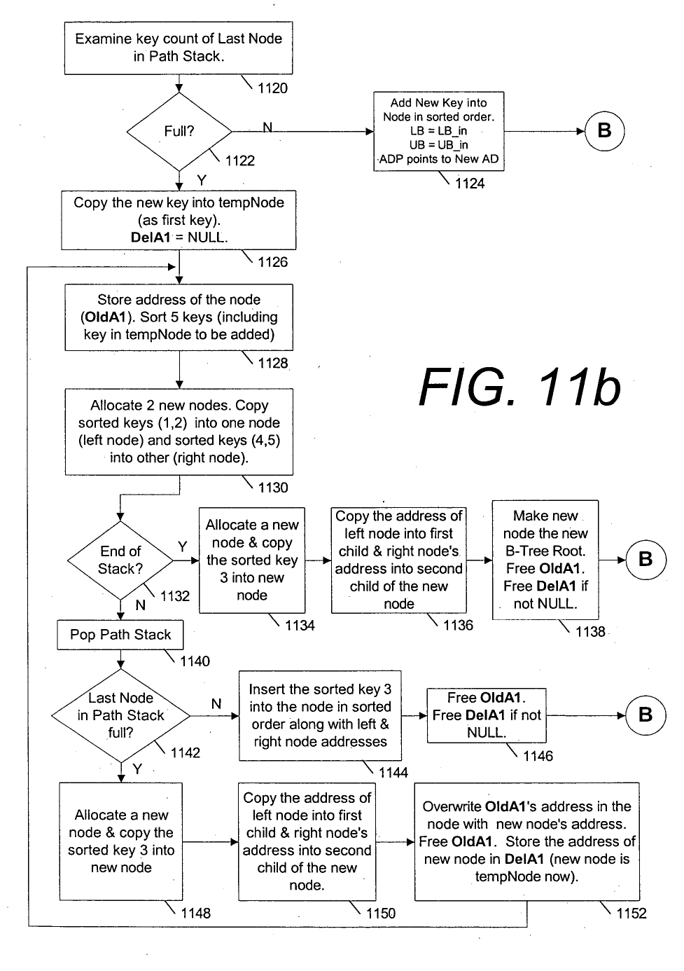

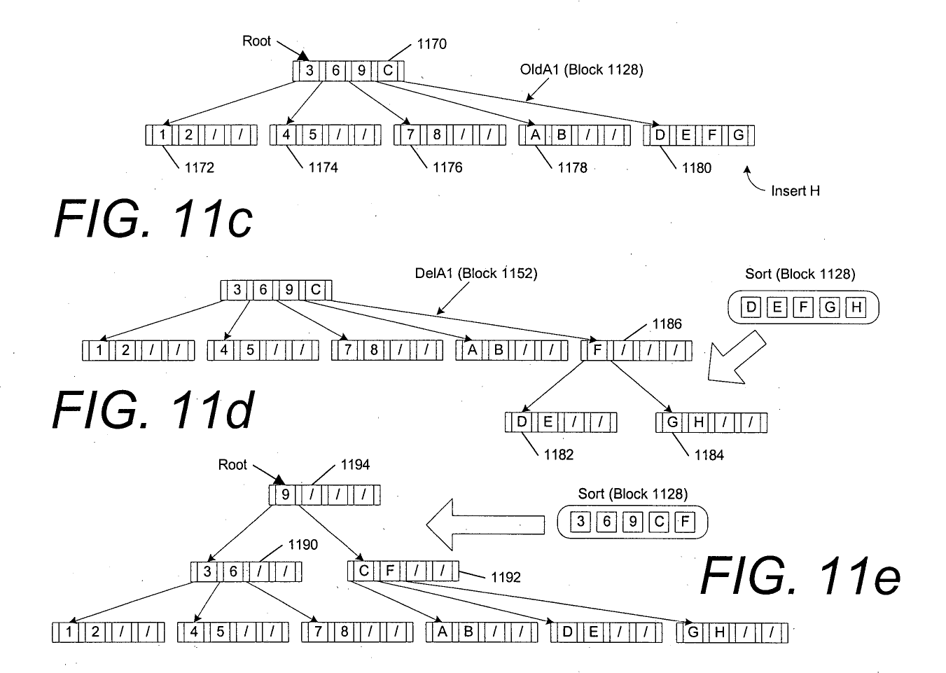

In block 602, whether the new range overlaps with an existing key is determined. If not, adding the new range may be relatively straightforward as a new key is added to accommodate the new range and new rule as indicated in block 604. Of course, inserting a new key may become quite complicated in and of itself because the new key may fragment other keys; however, that complexity will be discussed in further detail with respect to FIGS. 11a and 11b.

If the new range overlaps an existing key range, then several possibilities exist. Adding the new range is handled in block 606 if the new range is equal to the existing range. In block 606, the new rule is added to the sorted list of rules already associated with the existing key for the existing range.

If the new range is smaller than and falls within an existing range, then the existing range is fragmented as indicated in block 608. To fragment the existing range, the existing key itself is split or fragmented. An overlap portion exists where both ranges overlap. New fragments of the existing range are created in regions where the existing and new ranges do not overlap. As indicated in block 610, the fragment portions are inserted, possibly causing further fragmentation, and the existing key is updated to indicate both the existing and the new rule. In some embodiments, the existing rule fragments are first inserted so that the tree remains functional during the insert procedure. In some cases, an existing key fragment may be inserted to be temporarily overlapping with respect to the new range, and then later adjusted, again facilitating operation of the tree during the insertion process. Additionally, the ordering may vary depending on whether the existing or new data item takes precedence.

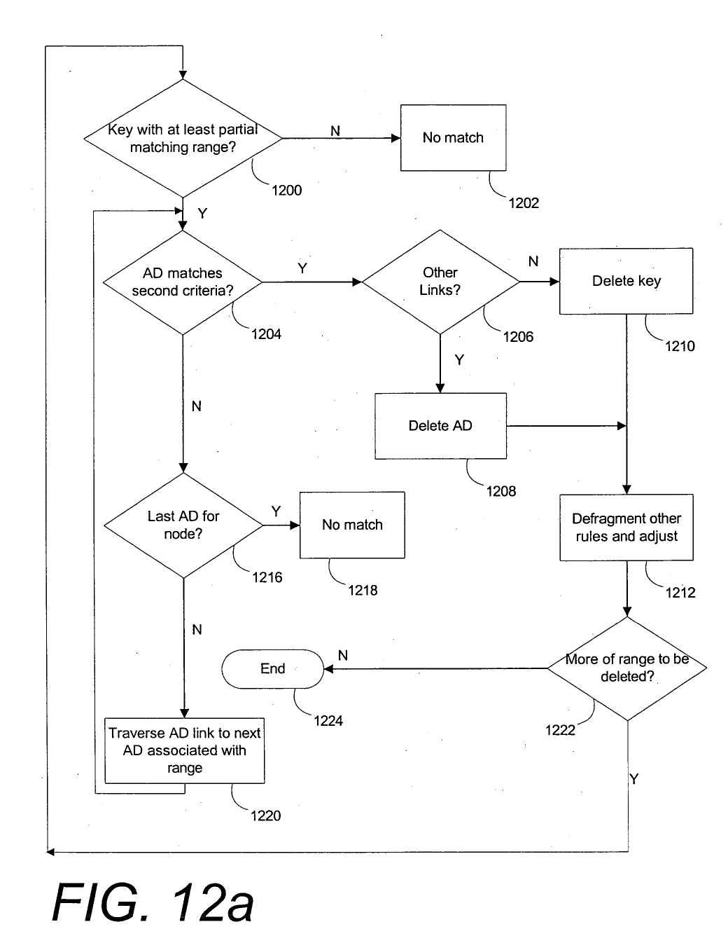

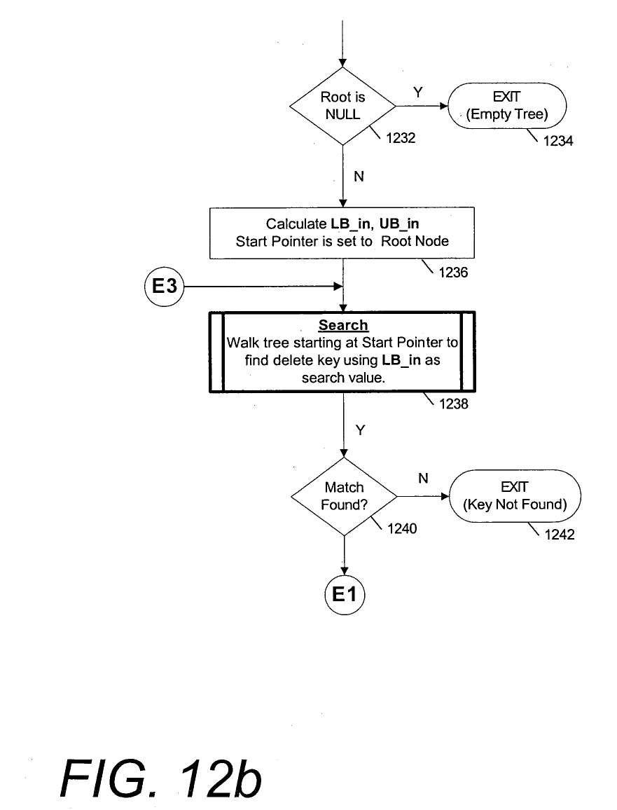

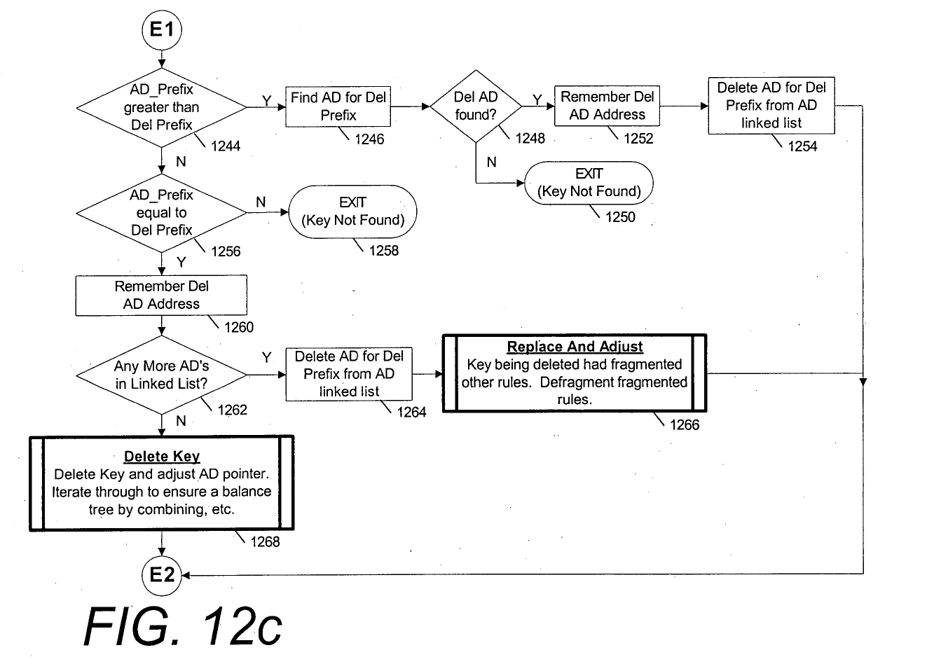

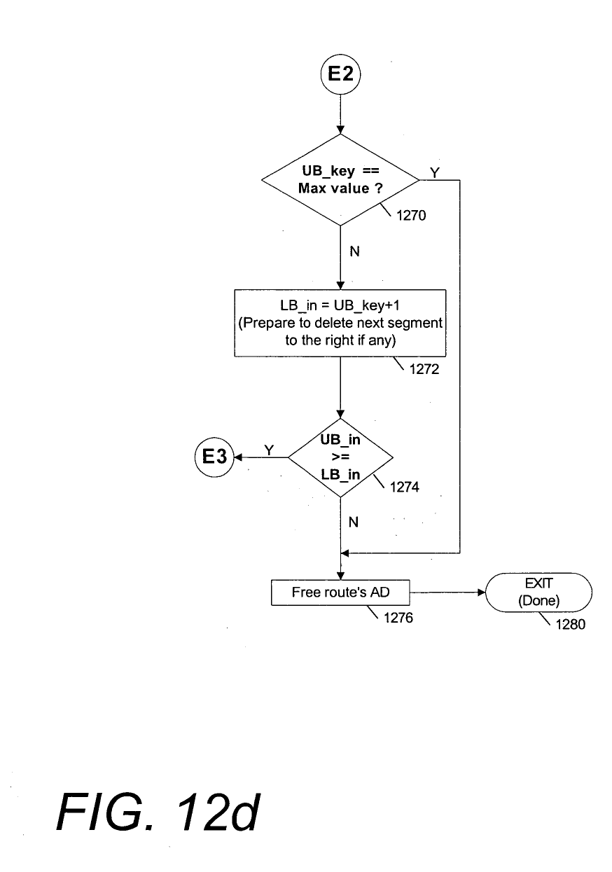

If the new range extends beyond the existing key, then the new range is fragmented as indicated in block 614. To fragment the new range, the new range is split into an overlap portion and a fragment. In this case, the fragment portion is inserted and the existing key is updated to indicate the new rule as indicated in block 616. Notably, the existing key range may need to be fragmented as well in some cases because the new range may not extend to cover the complete existing key range. Additionally, the added fragment may overlap another range and therefore need to be further fragmented. Thus, once again, several fragments may be created. Various orderings of fragment insertion, key update, and range adjustment may occur depending on the exact range overlaps and non-overlaps as well as depending on whether the new or existing data item takes precedence. Accordingly, various new ranges may be added by the process of finding overlaps and appropriately fragmenting the existing and/or new ranges. Preserving the old rules when new rules are added facilitates rule deletion as will be further discussed below with respect to FIGS. 12a and 12b. Moreover, carefully fragmenting and updating rules allows the data structure to be searched and still return valid results even when updates are only partially completed.

Turning to a more detailed example, FIG. 6b illustrates a first portion of an add process according to one embodiment. As indicated in block 622, various preparatory steps are performed. A lower bound (LB_in) and an upper bound (UB_in) for the new range are calculated. A new associated data (AD) is allocated and a pointer to the AD obtained. The new data (e.g., a new rule) is placed in the allocated AD. Finally, the start pointer for the search is set to the root node of the tree.

Whether the root node is null is tested in block 624. If the root node is null, then the tree is empty. In this case, a new node is allocated and the key to be inserted is written to the new node as indicated in block 626. The new node is set to be the root node, as indicated in block 626. As indicated in block 628, the add process completes when the root node is added in this case.

If the root node is not null (as tested in block 624), then a search is performed, starting at the start pointer using LB_in as a search value, as indicated in block 630. This search finds a place to insert a new key for the new range. In this case, the search of block 630 may be performed according to the search technique described in FIG. 5a. Block 630 and various other blocks are bolded to indicate that another figure further details operations in that block. In some embodiments, these additional processes may be used, but in other embodiments the more specific processes may not be used. If no match for LB_in is found, as tested in block 632, the add process continues on to FIG. 6c via a connector circle labeled “C” (“connector C”) in both FIGS. 6b and 6c.

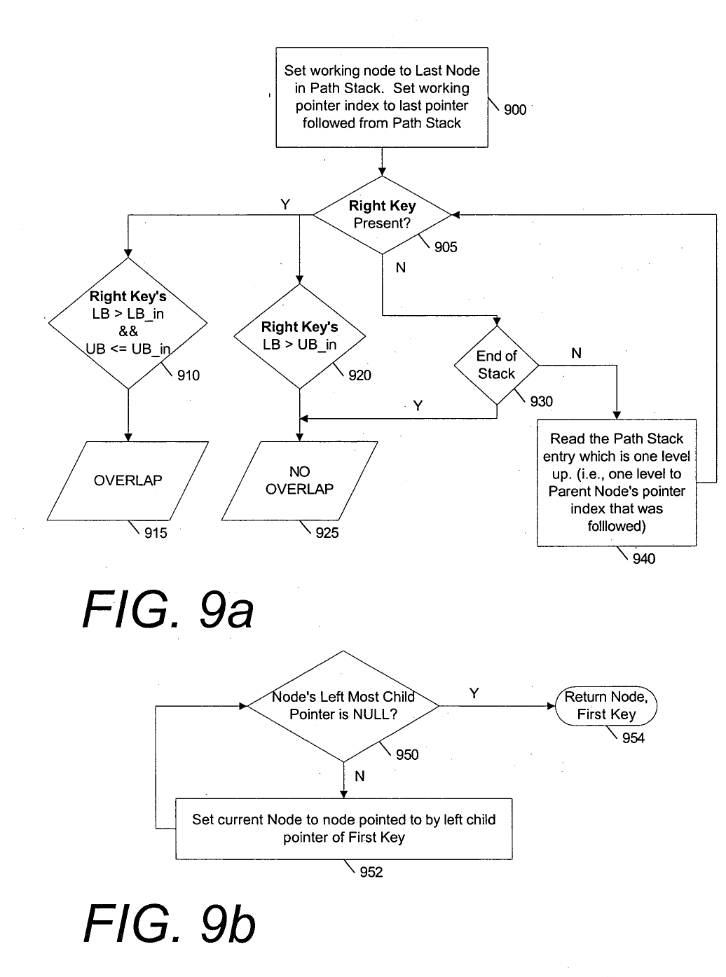

In block 661 (see FIG. 6c), a next greater key is found. The next greater key may be a key above the current node in the tree or a key to the right or below the current node in the tree. Thus, it may be desirable to back up to the last node in the path stack created in the search flow. FIGS. 9a and 9b illustrate example embodiments of techniques to find the next greater key as will be further discussed below.

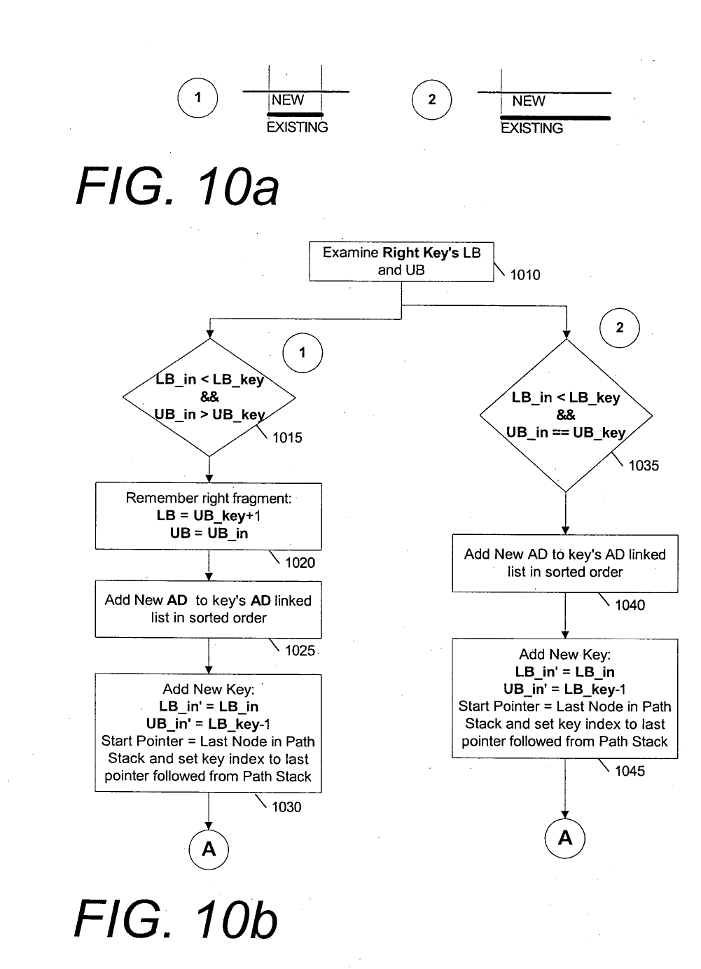

Once the next greater key is found, whether the next greater key overlaps with the new key is determined in block 662. If there is an overlap, then an add overlap and fragment procedure may be used to add the overlap portion and create the fragment portion. The new associated data is added to the overlapping AD linked list of the next greater key (see, e.g., FIGS. 10a and 10b for an example embodiment of an overlap and add process). The fragment portion is then processed, by proceeding to block 630 in FIG. 6a via connector A. In block 630, a search is once again performed (see, e.g., FIG. 5a). The search is performed with the LB_in being the lower bound of the fragment.

If the next greater key does not overlap with the new key (as tested in block 662 of FIG. 6c), then there is no overlapping range, and a new key may be inserted. Thus, as indicated in block 670, an insert procedure is followed. The new key is inserted in the last path stack node (i.e., the same node as the next greater key). However, if that node is full, the node may be split and a key promoted (see, e.g., FIGS. 11a and 11b for key insert processes).

At this point in the flow diagram of FIG. 6c, various additional fragments may need to be added and/or adjustments made in some cases in blocks 672-692. However, in the case presently being discussed, the flow progresses to block 694 because there were no adjustments or fragments.

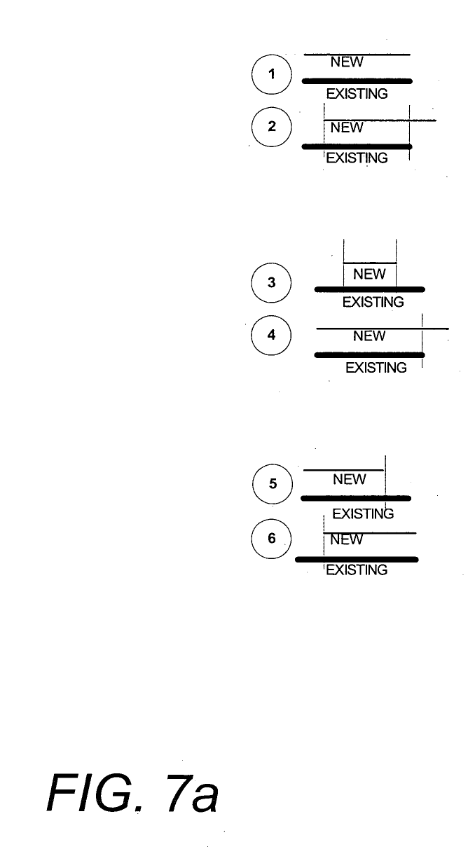

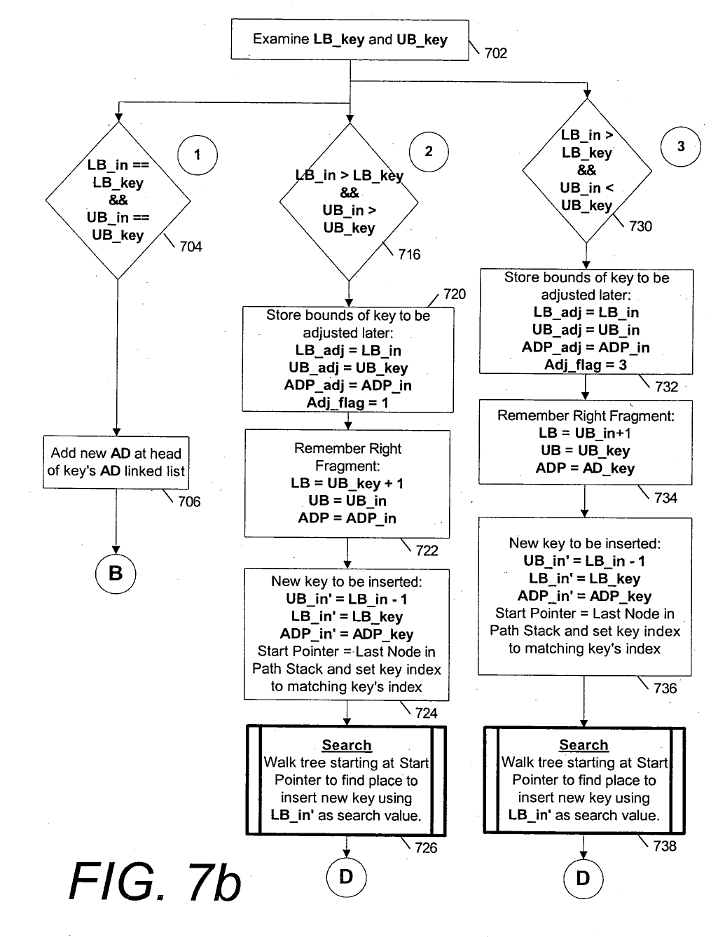

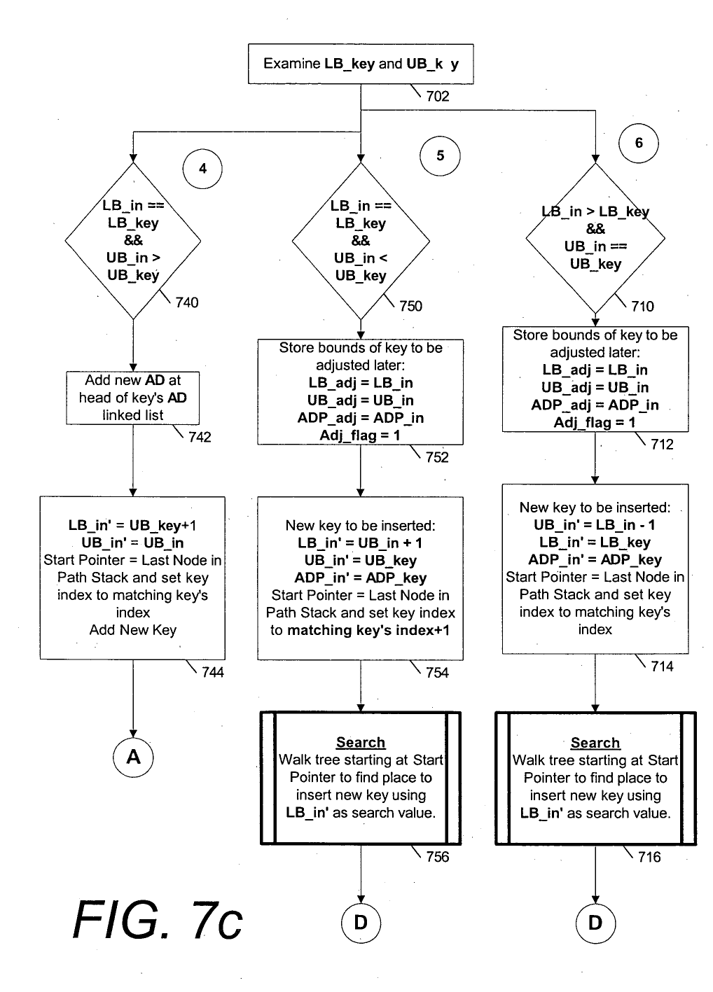

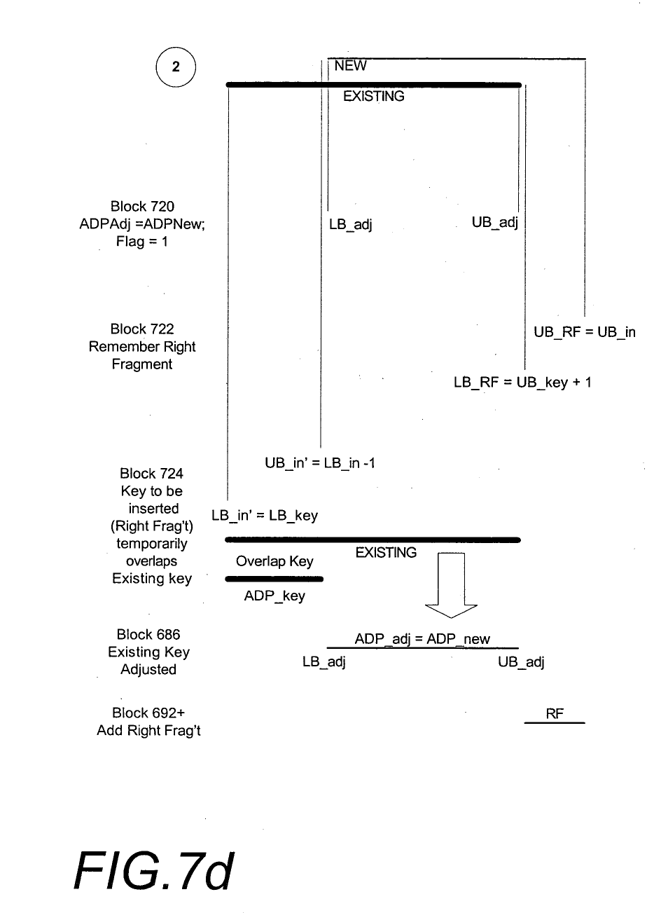

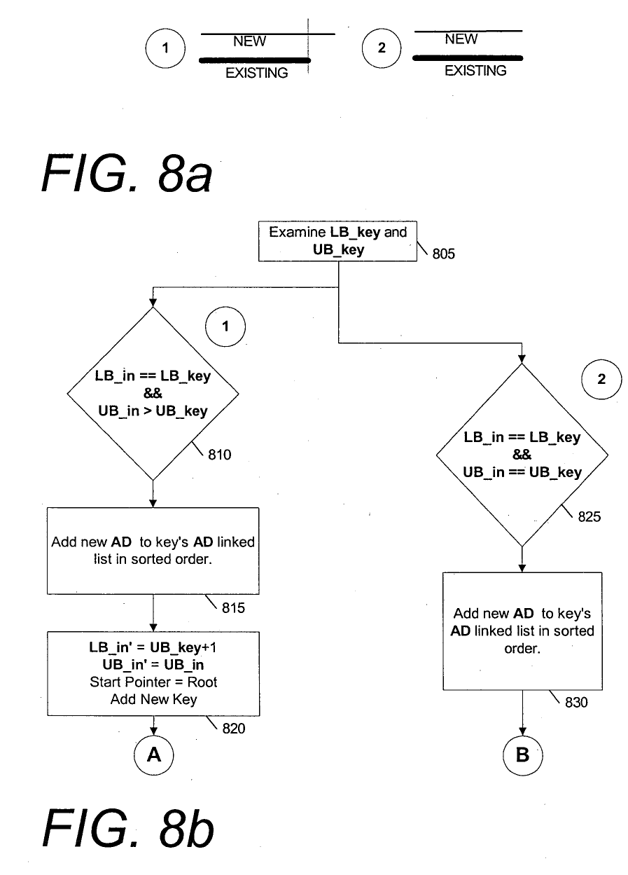

Returning to block 632 of FIG. 6b, if a match for LB_in is found, then a prefix compare operation is performed as indicated in block 634 (see, e.g., FIG. 5b). As a result of the prefix compare operation, the new prefix will be either equal, longer, or shorter than the existing prefix, as indicated in block 636. If an equal prefix length is found, then the add routine exits because adding another key would create a duplicate key as indicated in block 638. If the new rule has a longer prefix (i.e., it is a shorter range), then a longer prefix fragment insert procedure is followed as indicated in block 640 (see, e.g., FIGS. 7a-7d). If the new rule has a shorter prefix (i.e., it is a longer range), then a shorter prefix fragment insert procedure is followed as indicated in block 642 (see, e.g., FIGS. 8a and 8b).

With respect to the longer prefix fragment situation, FIG. 7a depicts six different longer prefix fragment insert cases. In each case, the new range has a new rule that is associated with a longer prefix that takes precedence over shorter prefixes according to one embodiment. FIGS. 7b and 7c illustrate processes to handle these different scenarios. In block 702 of FIG. 7b, the new range is compared to the existing key range. In the first case, case 1 shown in FIG. 7a, the new range matches the existing key range (block 704). Although the range matches, the new prefix is longer (i.e., of higher priority than the existing prefix) as determined by the previous prefix compare in block 634 of FIG. 6b. In this case, the new rule is added as the first or highest priority prefix. The new rule may be placed effectively at the head of a linked list of associated data for the key as indicated in block 706. In one embodiment, the AD pointer tracks the head and the ADL pointers and SPD data structures track the remainder of the linked list.

In the second case in FIG. 7a, case 2, the existing key range starts before the new range and ends before the new range. This situation is reflected in block 716 of FIG. 7b (LB_in>LB_key and UB_in>UB_key). Additionally, a detailed range diagram for this particular case is shown in FIG. 7d. In this case, the bounds of the key used for later adjustments are stored as indicated in block 720. A lower bound for adjustment (LB_adj) is set to the lower bound of the new range (LB_in). An upper bound for adjustment (UB_adj) is set to the upper bound of the key. An AD pointer for adjustment (ADP_adj) is set to the AD pointer for the input (ADP_in), and the adjustment flag (Adj_flag) is set to one. These values are graphically depicted in the range diagram of FIG. 7d.

Next, in block 722, the right fragment is stored for later addition to the data structure. The right fragment has a lower bound equal to the upper bound of the key plus one, and an upper bound equal to the upper bound of the new range (again, see FIG. 7d). The associated data for the right fragment is the associated data for the new range, so the AD pointer for the fragment is the input AD pointer

In block 724, the new key to be inserted is defined. As indicated in block 724, the new key to be inserted has a lower bound (LB_in′), an upper bound (UB_in′), and an associated data pointer (AD_in′). The lower bound of the overlap key (LB_in′) is the lower bound of the existing key. The upper bound of the new key (UB_in′) is the lower bound of the new range minus one (LB_in−1), and the associated data pointer is the AD pointer of the existing key. Thus, first, the right segment of the existing key that has a non-overlapping range with respect to the new range is inserted as a first new key. The start pointer is set to the last node in the path stack and the key index is set to a key index for the matching key.

As indicated in block 726, a search is performed, walking the tree starting at the start pointer to find a place to insert the new key using LB_in′ as the search value. At this point, connector D connects to block 670 in FIG. 6c. In block 670, an insert operation is performed to insert the new key in the last path stack node (see, e.g., FIGS. 11a-11b). If the node is full, split and promote operations may be undertaken. Notably, until the existing key range is adjusted, the key for this right segment and the existing key are valid keys that do overlap (see FIG. 7d). However, they do not contain inconsistent data (both pointers store the ADP of the existing key). Also, this situation is temporary in this embodiment because the existing key is later adjusted to be non-overlapping.

Thus, after performing the key insert operation per block 670, in this case, there are some adjustments to be made. However, the adjust flag (Adj_flag) is not equal to three as tested in block 672. Therefore, processing continues to block 680. Since the adjust flag is set to two, block 680 tests true and processing continues to block 682 where the adjust flag is reset to zero. Thereafter, a search is performed, as indicated in block 684, starting from the root node to find a search value of LB_adj (as set in this case in block 720). In this case, the LB_adj was set to the lower bound of the original new range. Therefore, when LB_adj is searched in the tree, the original existing key is found to match. The matching key is then modified as indicated in block 686, so that the key lower bound is set to the LB_adj value, the key upper bound value is set to UB_adj, and the associated data pointer is set to the associated data pointer for the adjusting key (ADP_adj) as shown in FIG. 7d. Additionally, the associated data pointer of the previously existing key may be saved in the linked list of associated data. The new key takes precedence, though, because this operation is an instance of a longer prefix fragment insert. Accordingly, the original existing key is modified so that it no longer overlaps the new left fragment that was just added prior to the adjustment.

Block 690 may be arrived at if either the adjust flag is not one or two as tested in block 680, or after block 686. In this case, we arrive from block 686. Whether there are any additional remaining fragments is tested in block 690. In other situations, if no remaining fragments are found in block 690, then the add process completes at this point, as indicated in block 694. If there are remaining fragments (as is the case in this scenario, see block 722 of FIG. 7b), then the LB_in value is set to the fragment lower bound, the UB_in value is set to the fragment upper bound, and the start pointer is set to the root node as indicated in block 692. The fragment is added by returning to block 630 via connector A. In this case, the right fragment saved in block 722 is added last.

Thus, in case 2 in FIG. 7a, the left fragment is added first, then an adjustment is made to the existing key to provide the middle segment, and then the remaining right fragment of the new key is added. Therefore, the existing key is preserved, allowing concurrent search operations to be performed while the fragmentation and adding processes also occur.

With respect to case 3 in FIG. 7a, the new range now is smaller than and falls within the existing key. In this case as well, the existing key portions are inserted first to allow searching of the tree to continue during update. In case 3, as indicated in block 730, the lower bound of the new range is greater than the lower bound of the existing key (LB_in>LB_key) and the upper bound of the new range is less than the upper bound of the existing key (UB_in<UB_key). As indicated in block 732, in this scenario, the bounds of the key to be adjusted later are stored. LB_adj is set to LB_in, UB_adj is set to UB_in, ADP_adj is set to ADP_in, and the adjust flag is set to three. Therefore, the adjusted key range will span the range covered by both the new range and existing key range.

Continuing to block 734, the right fragment is stored for later insertion The right fragment lower bound is the upper bound of the new range plus one (LB_in+1). The right fragment upper bound is the upper bound of the existing key, and the right fragment associated data pointer is the associated data pointer of the existing key since the right fragment is only covered by the existing key and is not within the new range. Next, as indicated in block 736, a new key is prepared for insertion. The upper bound of the new key to be inserted is set to the lower bound of the new range minus one (UB_in′=LB_in−1). The lower bound of the new key is set to the lower bound of the existing key (LB_in′=LB_key). Thus, the new key covers the left segment of the existing key up to the start of the new range. Therefore, the AD pointer of the new key is set to the AD pointer of the existing key. The start pointer for a search is set to the last node in the path stack, and the key index is set to the key index of the matching key (the existing key). Then, a search is performed, as indicated in block 738, walking the tree starting at the start pointer to find a place to insert the new key using LB_in′ as the search value. At this point, connector D connects to block 670 in FIG. 6c. In block 670, an insert operation is performed to insert the new key in the last path stack node (see, e.g., FIGS. 11a-11b). If the node is full, split and promote operations may be undertaken.

After performing the key insert operation per block 670, in this case, there are some adjustments to be made. Whether the adjust flag is set to three is tested in block 672, and in this case, it is. Thus, the adjust flag is decremented to two as indicated in block 674, and another search is performed as indicated in block 676. The search of block 676 starts at the root node to find a search value of LB_adj (as set in block 732 in this case). Next, as indicated in block 678, a search is performed starting at the right child of the matching key found in block 676 to find a place to insert the stored right fragment using its lower bound as a search value. Thereafter, the add procedure returns to block 670 where an insert operation is performed. This operation adds the right fragment. Now, since the adjustment flag is set to 2, the add procedure performs operations indicated in blocks 682, 684, and 686, etc, adding the new rule for the new range and adjusting the key range to cover only the new range. Thus, for case 3, first the left key is added, then the right key is added, then the overlapping key portion is updated.

Case 4 in FIG. 7a illustrates a situation in which the new range is longer than and extends beyond the existing key. In particular, as indicated in block 740, in this case, the lower bound of the new range is equal to the lower bound of the existing key (LB_in=LB_key) and the upper bound of the new range is greater than the upper bound of the existing key (UB_in>UB_key). In this case, a new associated data is added at the head of the existing key linked list of associated data as indicated in block 742. Next, a new lower bound is set to the upper bound of the existing key plus one (LB_in′=LB_key

+1), and a new upper bound is set to the upper bound of the new range (LB_in′=UB_in). As indicated in block 744, additionally, the start pointer for a search is set to the last node in the path stack, and the key index is set to a key index for the matching key. The new key is inserted by following connector A to block 630 in FIG. 6b and the appropriate following steps. Thus, for case 4, first the AD linked list is added, and then the fragment on the right is updated.

With respect to case 5, the new range is contained fully within the range of the existing key and the lower bounds are equal. In this scenario, as indicated in block 750, the lower bound of the new range equals the lower bound of the existing key (LB_in=LB_key) and the upper bound of the new range is less than the upper bound of the existing key (UB_in<UB_key). In this case, as indicated in block 752, again bounds of the key to be adjusted later are stored. LB_adj is set to LB_in, UB_adj is set to UB_in, and the ADP_adj is set to the ADP_in. Additionally, the adjust flag is set to one. In block 754, the new key to be inserted has a lower bound set to the upper bound of the new range plus one (LB_in′=UB_in+1). The upper bound of the new key is set to the upper bound of the existing key (UB_in′=UB_key). Thus, the right segment is to be inserted first. The associated data pointer of the new key is set to the associated data pointer of the existing key since the new range does not cover this right segment. The start pointer for a search is set to the last node in the path stack, and the key index is set to the key index of the matching key plus one. Then, a search is performed, as indicated in block 756, walking the tree starting at the start pointer to find a place to insert the new key using LB_in′ as the search value. At this point, connector D connects to block 670 in FIG. 6c. In block 670, an insert operation is performed to insert the new key in the last path stack node (see, e.g., FIGS. 11a-11b). If the node is full, split and promote operations may be undertaken.

After performing the key insert operation per block 670, in this case, there are some adjustments to be made. Since the adjustment flag is set to one, operations from blocks 682, 684, and 686 are performed, resulting in the previously present key being adjusted in size to new range and to first point to the new rule associated with the new range because of its longer prefix. Thus, the right fragment is inserted first in case 5, and then the existing key is updated with the new rule.

In case 6 of FIG. 7a, the new range falls within the range of the existing key. More specifically, as indicated in block 710, in case 6, the lower bound of the new range is greater than the lower bound of the existing key (LB_in>LB_key) and the upper bound of the new range is equal to the upper bound of the existing key (LB_in=LB_key). In this case, the bounds of the key to be adjusted later are once again stored as indicated in block 712. In particular, LB_adj is set to LB_in, UB_adj is set to UB_in, and the ADP_adj is set to ADP_in. The adjustment flag is also set to one. The new key to be inserted is prepared in block 714. The new key upper bound is set to the lower bound of the new range minus one (UB_in′=LB_in−1). The new key lower bound is set to the lower bound of the existing key (LB_in′=LB_key). Thus, the left segment is added first, and the associated data pointer of the new key is set to the associated data pointer of the existing key because the new range does not cover the left segment. The start pointer for a search is set to the last node in the path stack, and the key index is set to the key index of the matching key plus one. Then, a search is performed, as indicated in block 716, walking the tree starting at the start pointer to find a place to insert the new key using LB_in′ as the search value. At this point, connector D connects to block 670 in FIG. 6c. In block 670, an insert operation is performed to insert the new key in the last path stack node (see, e.g., FIGS. 11a-11b). If the node is full, split and promote operations may be undertaken.

After performing the key insert operation per block 670, in this case, there are some adjustments to be made. Since the adjustment flag is set to one, operations from blocks 682, 684, and 686 are performed, resulting in the previously present key being adjusted to have the same range as the new rule and to include the new rule. Thus, the left fragment is inserted first in case 6, and then the existing key is updated.

In the case of a shorter prefix fragment insert, two cases are shown in FIG. 8a. The relationship between the old and new ranges is determined in block 805. In case 1, the new range extends beyond the existing key range. More particularly, as indicated in block 810 of FIG. 8b, the lower bound of the new range equals the lower bound of the existing key (LB_in=LB_key) and the upper bound of the new range is greater than the upper bound of the existing key (UB_in>LB_key). In this case, the new associated data is added to the linked list of associated data for the existing key in sorted order as indicated in block 815. Next, as indicated in block 820, a new key is defined for insertion. A new key lower bound is set to the existing key upper bound plus one (LB_in′=LB_key+1). A new key upper bound is set to the upper bound of the new range (UB_in′=UB_in). The start pointer for a search is set to the root node, and the new key is added by following connector A to block 630.

In Case 2 of FIG. 8a, the new and existing ranges are the same. Thus, in this case, as indicated in block 825, both the upper and lower bounds of the new and existing key ranges are equal (LB_in=LB_key and LB_in=LB_key). Therefore, the new associated data is added to the linked list of the existing key in sorted order as indicated in block 830. Since the new prefix is shorter in this case, it is added after the head of the linked list. Thereafter, processing continues via connector B to block 672, et seq., in FIG. 6c.

As previously mentioned, at times the next greater key is sought for various reasons (see, e.g., block 661 of FIG. 6c). FIG. 9a illustrates one embodiment of a find next greater key (up) process to find the next greatest key, numerically, which is above the current location in the tree. As indicated in block 900, the working node is set to the last node in the path stack, and the working pointer index is set to the last pointer followed from the path stack. Whether or not a key to the right is present is tested in block 905. If the right key is present, two situations are possible. The first situation is that the right key lower bound is greater than the lower bound of the new range and the upper bound of the right key is less than or equal to the upper bound of the new range as indicated in block 910. In this case, an overlap occurs as indicated in block 915 and a next greater key above has been found. In the second situation, the right key lower bound is greater than the upper bound of the new range as indicated in block 920. In this case, no overlap occurs as indicated in block 925.

If no right key is present, whether the end of the stack has been reached is tested in block 930. If the end of the stack has been reached, then no overlap occurs as indicated in block 925. If the end of the stack has not been reached, then the path stack entry which is one level up is read next as indicated in block 940, and the process returns to block 905, eventually either finding a next greater key above or exhausting the path stack.

FIG. 9b illustrates one embodiment of a find next greater key (down) process. To find the next greater key (down), whether or not the current node leftmost pointer is null is tested in block 950. If the current node leftmost pointer is null, then the node first key is returned as a next greater key as indicated in block 954. If the current node leftmost pointer is not null, then the current node pointer is set to the node pointed to by the left child pointer of the first key in that node as indicated in block 952. Thereafter, the process returns to block 950 and continues until the current node leftmost pointer is null, at which point, the first key of that node is returned as indicated in block 954.

FIGS. 10a and 10b illustrate details of an add overlap and fragment process according to one embodiment. As indicated in FIG. 6c (see, e.g., blocks 664 and prior blocks), an add overlap and fragment process may be used when no lower bound match is found for a new range, but a next greater key overlaps with the new range. FIG. 10a illustrates two add overlap and fragment cases. As indicated in block 1010 of FIG. 10b, the upper bound and the lower bound of the new range and the existing key are examined to determine which case is being processed. In the first case, case 1, the new range extends beyond both sides of the existing range. Thus, in case 1, the lower bound of the new range is less than the lower bound of the existing key (LB_in<LB_key), and the upper bound of the new range is greater than the upper bound of the existing key (UB_in>UB_key) as indicated in block 1015. In this case, the right fragment is stored for later addition as indicated in block 1020. In particular, the right fragment has a lower bound equal to the upper bound of the existing key plus one, and an upper bound of the new range upper bound. As indicated in block 1025, the new associated data is added to the associated data linked list for the existing key in sorted order.

A new key is then defined for adding to the data structure in block 1030. The new key lower bound is set to the new range lower bound (LB_in′=LB_in). The new key upper bound is set to the lower bound of the existing key minus one (UB_in′=LB_key−1). The start pointer for a search is set to the last node in the path stack and the key index is set to the last pointer followed from the path stack. Thereafter, the process continues via connector A to FIG. 6b and block 630, et seq. Thus, in case 1, the new AD is added, then the left fragment, then the right fragment.

In case 2 of FIG. 10a, the new range only extends to the right of the existing key. More particularly, in case 2, the lower bound of the new range is less than the lower bound of the existing key (LB_in<LB_key) and the upper bound of the new range is equal to the upper bound of the existing key (UB_in=LB_key) as indicated in block 1035. In this case, the new associated data is added to the existing key associated data linked list in sorted order as indicated in block 1040. Then, the new key is defined for addition as indicated in block 1045. The new key lower bound is set to the lower bound of the new range (LB_in′=LB_in). The new key upper bound is set to the lower bound of the existing key minus one (UB_in′=LB_key−1). The start pointer for a search is set to the last node in the path stack and the key index is set to the last pointer followed from the path stack. Thereafter, the process continues via connector A to FIG. 6b and block 630, et seq. Thus, in case 2, the new AD is added to the existing key, then a key for the left fragment is added to the tree.

FIG. 11a illustrates a key insert process according to one embodiment. According to the embodiment of FIG. 1a, key insertion begins by first finding the appropriate node into which the new key should be inserted based on the key range as indicated in block 1102. Whether or not the correct node is full is tested in block 1104. If the node is not full, then the new key is added to the node as indicated in block 1106. If, however, the node is full, then the node is split via a split process 1108. First, the N keys in the node and the new key are sorted as indicated in block 1110. The sequentially lower keys are stored in the a first new node as indicated in block 1112. For example, in one embodiment, half of the keys may be stored in the first node. However, other numbers of keys may be stored in the first node. The upper keys are stored in a second new node as indicated in block 1114. Again, half of the keys or some other number may be stored in the second new node. The middle key or keys (depending on how many keys were stored in the upper and lower portion nodes) are stored in a temporary node as indicated in block 1118. The current node is set to the parent node of the node which was full and into which insertion of the original key was attempted, and the process returns again to block 1104 where an attempt is made to insert the key in the temporary node with two newly created child nodes into this new current node.

The process continues, iterating until room for the new key has been made. Meanwhile, each iteration uses a temporary node that might not comply with the B-Tree guideline to keep N/2 or more keys in each node because it might be a non-root node that has only a single key. This node is, however, only temporary, and will only last until the next insert operation is completed in this embodiment. The use of the temporary node advantageously allows continuing search via the tree structure between iterations of the insert operation; however, the worst case tree depth may increase by one node due to the temporary node in one embodiment. Additionally, other embodiments may have more relaxed rules as to when temporary nodes are removed. For example, a periodic clean-up process could instead remove low key count nodes. In embodiments allowing multiple concurrent key inserts, multiple temporary nodes could exist in a single path in some cases.

FIG. 11b illustrates a detailed insert process according to one embodiment. In this embodiment, the process also begins with examining a key count in the last node in the stack path as indicated in block 1120. Whether or not the last node is full is tested in block 1122. If the node is not full, then the new key is added in sorted order to the node as indicated in block 1124, and the process returns via connector B to block 672 in FIG. 6c. Depending on what led to the activation of the insert process, further adjustments and additions may be needed.

If the node is determined to be full in block 1122, then the new key is copied into a temporary node as the first key as indicated in block 1126. A DelA1 pointer is also set to null in block 1126. Next, as indicated in block 1128, the address of the current node is stored (OldA1). The five keys, including the new key and the four keys from the current node are sorted as indicated in block 1128. Also, in block 1128, the current node needs to be remembered. Thus, the an OldA1 pointer address pointing to the node is stored for later use. Next, as indicated in block 1130, two new nodes are allocated. The first two sorted keys are copied to the left node and the last two sorted keys are copied to the right node as indicated in block 1130.

Whether or not the end of the path stack has been reached is then tested in block 1132. If the end of the path stack has been reached, then a new node is allocated and the sorted middle key is inserted into the newly allocated node as indicated in block 1134. Next, the address of the left node is copied into the first pointer of the new node and the address of the right node is copied into the second pointer of the new node as indicated in block 1136. Finally, in block 1138, the new node is made the new root, and the data structures pointed to by OldA1 and DelA1 may be freed. Thereafter, the process returns via connector B to block 672 in FIG. 6c. Depending on what led to the activation of the insert process, further adjustments and additions may be needed.

If block 1132 indicates that the end of the path stack has not been reached, then another node is popped from the path stack and made the current node in block 1140. Whether this new current node is full is tested in block 1142. If the new current node is not full, then the sorted key is inserted into the new current node in sorted order along with left and right node addresses as indicated in block 1144. Again, the data structures pointed to by OldA1 and DelA1 may be freed as indicated in block 1146. Thereafter, the process returns via connector B to block 672 in FIG. 6c. Depending on what led to the activation of the insert process, further adjustments and additions may be needed.

If the determination in block 1142 is that the new current node is also full, then processing continues to block 1148, in which a new temporary node is allocated, and the middle key from the above sorting in block 1128 is copied into the new temporary node. Next, as indicated in block 1150, the address of the left node from block 1130 is copied into the first pointer of the new node, and the address of the right node from block 1130 is copied into the second pointer of the new node. Thereafter, as indicated in block 1152, the OldA1 pointer is overwritten with the new node address. The data structure for the OldA1 pointer may then be freed as well. As also indicated in block 1152, the address of the new node is stored as DelA1, making the new node the temporary node at this point.

With the temporary node inserted into the tree data structure, the tree data structure is functional. In other words, a search can be performed on the tree at this point. The ability to separate the sometimes iterative and lengthy insert process into discrete iterations with intermediate points that leave a functional tree may be very valuable in high speed lookup applications where tree searching needs to be performed very frequently and rapidly. The addition of this temporary node does add another layer, but may be far better than propagating an insert through the entire tree before allowing accurate searches to be performed. Continuing on, the process returns to block 1128, and eventually completes by either finding a node with space or moving all the way up to the root node.

FIGS. 11c-11e provide an example of an insert operation according to the embodiment of FIG. 1b. In this case, the ranges are represented as single numbers and letters for simplicity. As indicated in FIG. 11c, the tree starts with a first node 1170 having ordered keys 3, 6, 9, and C (with letters falling after numbers in sorted order in this example). The five pointers of node 1170 point (in order) to five child nodes, respectively 1172, 1174, 1176, 1178, and 1180. In this case, the insert process is attempting to insert the key H. A search operation on key H leads to node 1180 as being the appropriate node into which H should be inserted. Thus, node 1180 is the last node on the path stack from the search operation. In block 1120, it is determined that four keys already exist in the node 1180, and therefore block 1122 indicates that the node is full. Accordingly, in block 1126, the new key is copied into a temporary node. In block 1128, the address of the pointer OldA1 is stored.

As shown in FIG. 11d, block 1128 also sorts the five nodes D, E, F, G, H. In block 1130, D and E are copied to a node 1182 and G and H are copied to a node 1184.

Continuing on, the end of the path stack has not been reached because node 1180 was not the root node, so the path stack is popped, and the node 1170 is examined in block 1142 to determine that this node is also full. Since the node 1170 is full, processing continues to block 1148 where a new node 1186 is allocated and F is copied into the new node as also shown in FIG. 1d. In block 1150, pointers to nodes 1182 and 1184 are inserted into the node 1186 as shown in FIG. 11d. Proceeding to block 1152, the OldA1 pointer (see FIG. 11c) is overwritten such that the right pointer of key C in node 1170 (the last pointer in node 1170) is updated to point to the new node 1186 as shown in FIG. 11d. The temporary pointer DelA1 is set to point to the node 1186. At this point, the tree is searchable but has a child node 1186 with less than two keys.

Processing returns to block 1128, and, as shown in FIG. 1e, the keys 3, 6, 9, F, and C are sorted in block 1128. In block 1130, keys 3 and 6 are copied to a new left node 1190 and keys F and C are copied to a new right node 1192 as shown in FIG. 11e. Since we have reached the end of the path stack, block 1134 is performed next, and a new node 1194 is allocated to store key 9. The first and second pointers for the new node 1194 are updated to point to nodes 1190 and 1192 respectively as indicated in block 1136, and thereafter the new node 1194 is made the root pointer to complete the tree alterations.

FIG. 12a illustrates a delete process according to one embodiment. The delete process seeks to delete a data item associated with a range and in some cases a second matching criteria (e.g., a particular range and prefix length or a route). A data item may be fragmented into multiple keys. Therefore, multiple keys may need to be modified or deleted. According to the process of FIG. 12a, block 1200 determines whether a key with an at least partially matching range exists (e.g., starting at the same lower bound). The range to be deleted may be fragmented into multiple keys in some cases. Therefore, multiple segments may need to be deleted to delete the entire data item. If there is no key with an overlapping range, then the delete process terminates as indicated in block 1202. If a match does occur, then, as indicated in block 1204, the first associated data for the key is compared for a match with the second criteria (e.g., a search of a linked list of associated data may be performed). If an AD match is found in block 1204, then whether there are other links in the matching key is determined in block 1206. If there are other links in the matching key, then the key can be retained and only the particular associated data is deleted from the linked list, as indicated in block 1208. The rule that was just deleted may have been the cause of fragmentation of other rules in the tree. Therefore, as indicated in block 1212, other rules are de-fragmented and adjusted. Thereafter, it is determined in block 1222 whether more of the range remains to be deleted. In other words, block 1222 determines whether the deleted portion completely covered the range to be deleted or whether the deleted portion was only one segment of the range to be deleted. If no more range segments need to be deleted, the delete process terminates as indicated in block 1224. However, if additional fragments exist, then the range is set to cover the not-yet-deleted portion of the range, and the process returns to block 1200.

If it is determined that there are no other links in block 1206, then the key itself has no more associated data and is deleted in block 1210. However, the rule that was just deleted may have been the cause of fragmentation of other rules in the tree. Therefore, as indicated in block 1212, other rules are de-fragmented and adjusted. Furthermore, there may be additional segments of the range to be deleted. Therefore, from block 1212, the process continues to block 1222 to delete any such remaining segments as previously discussed.

Returning to block 1204, if the first associated data for the matching key does not match, it is next determined in block 1216 whether that associated data is the last associated data for the key. If so, then no match was found as indicated in block 1218. If not, the next link is traversed to reach the next associated data for the range as indicated in block 1220, and the process returns to block 1204. Either a match is eventually found by such iteration, and the rule or data item deleted, or it is not present in the tree.

FIGS. 12b-12d illustrate a detailed delete process for one embodiment. The process of FIGS. 12b-12d seeks to delete a particular route (e.g., a rule or data item for a route). The route is characterized by a range and a prefix of a given length. In block 1232, whether the root of the tree is null is tested. If the root of the tree is null, then the tree is empty, no deleting can be performed, and the delete process exits as indicated in block 1234. If the root is not null, the lower bound and the upper bound of the key to be delete are calculated (LB_in, UB_in) and the start pointer for a search operation is set to the root node as indicated in block 1236.

Next, as indicated in block 1238, the search operation is performed and accordingly the tree is walked starting at the start pointer to find a delete key using the lower bound of the key to be deleted (LB_in) as the search value. Whether a match was found is checked in block 1240. If no match is found, then they key sought to be deleted is not in the tree, and hence the delete process ends as indicated in block 1242. If a match is found, then whether the associated data of the matching key has a longer prefix than the prefix to be deleted is tested in block 1244 of FIG. 12a as is reached via connector E1.

If the matching key prefix is longer, then it is possible that the matching prefix exists in the linked list of associated data for the matching key. Therefore, in this case, the process continues by traversing the linked list to find the associated data for the prefix sought to be deleted as indicated in block 1246. Whether or not the associated data to be deleted (e.g., data with a matching prefix length) is found by traversing the linked list is determined in block 1248. If the prefix to be deleted is not found by traversing the linked list, then the delete process exits as indicated in block 1250. If the prefix to be deleted is found, then the address of the associated data to be removed is stored for future use in de-fragmenting/adjusting as indicated in block 1252. Next, the associated data for the prefix to be deleted is removed from the linked list, as indicated in block 1254. Thereafter, the delete process continues via connector E2 to block 1270 in FIG. 12c, which will be further discussed below.

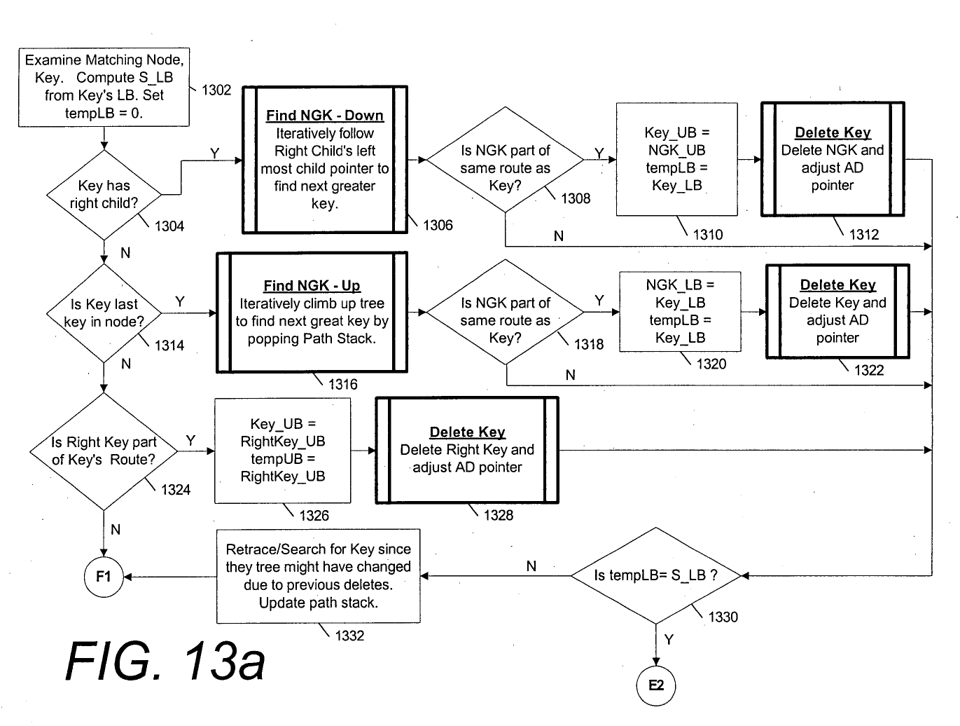

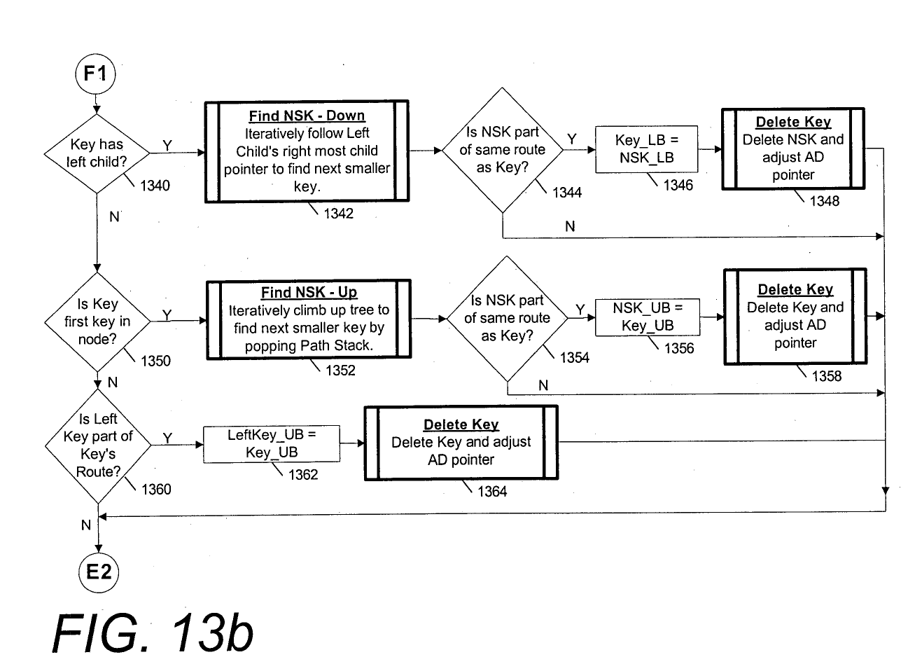

Returning to block 1244, if the associated data prefix is not greater than the prefix to be deleted, then whether the associated data prefix is the same as the prefix to be deleted is tested in block 1256. If not, then no match is found and the delete process is concluded, as indicated in block 1258. If the associated data prefix for the matching node is the same as the prefix to be deleted, then that associated data is to be removed, and is stored for future use in de-fragmenting/adjusting as indicated in block 1260. Moving to block 1262, whether any more associated data are included in the linked list is determined. If there are other associated data for the matching key, then the key itself need not necessarily be deleted since it stores links to other pointers. However, the associated data for the specified prefix to be deleted is removed from the linked list as indicated in block 1264. Because the deleted route may have caused fragmentation, a replace and adjust process is performed as indicated in block 1266 in order to de-fragment the rules previously fragmented by the now deleted route (see, e.g., FIGS. 13a and 13b). After block 1266, the delete process continues via connector E2 to block 1270 in FIG. 12c, which will be further discussed below.

If it is determined in block 1262 that there are no more associated data in the linked list of the matching key, then the key no longer would be needed in the tree. Therefore, in this case, the process moves from block 1262 to block 1268 where a key delete process is performed to delete the key. Additionally, the key delete process may iterate through the tree to ensure balance by combining, etc.

Thereafter, the delete process continues via connector E2 to block 1270 in FIG. 12c (the process may arrive at block 1270 from blocks 1254 or 1266 as well as noted above). If the range for the rule to be deleted was longer than the range of the first matching key, then additional fragments of the range are stored in other keys. Therefore, the process determines whether the range to be deleted was handled by the removal process so far, or whether additional pieces of the range to be deleted remain. Thus, in block 1270, whether the key from the link that was just removed has an upper bound of a maximum upper bound value (e.g., FFFFFFFF hexadecimal for a 32-bit address space) is tested. If the key has the same maximum upper bound, then no further fragments of the route to be deleted could exist, so the process drops to block 1276 where the associated data for the route is freed, and then the process exits in block 1280.

If the upper bound of the key is not the maximum upper bound, then an additional fragment potentially exists to the right of the key. A new lower bound is set to the upper bound of the key (LB_in=UB_key+1) to prepare to delete the next segment to the right if any as indicated in block 1272. Next, in block 1274, whether the upper bound of the original range is greater than or equal to the lower bound is tested. If not, then no additional segments to be deleted exist, and the process concludes via blocks 1276 and 1280 as previously discussed. If another segment to be deleted exists, then the process continues via connector E3 to block 1238, et seq., in FIG. 12b.

FIGS. 13a and 13b detail a replace and adjust process according to one embodiment. The replace and adjust process may be used when a route that is being deleted overlaps multiple segments stored in multiple keys (see, e.g., block 1266 in FIG. 12b). FIG. 13a covers overlap of the next greater key and FIG. 13b covers overlap with the next smaller key. In other embodiments, these may be handled in reverse order or in parallel. In block 1302 of FIG. 13a, a segment lower bound (S_LB) is computed from the lower bound of the key and the prefix of the key, and a temporary lower bound is set to zero (tempLB=0). A key for part of a fragmented range will not have its upper bound and lower bound set to cover the entire range indicated by the prefix, but the entire range can be found from the lower bound (which at this point is the first portion of the range) and the prefix, which defines the total length (and may be stored in the associated data).

Whether the key has a right child is determined in block 1304. If the key has a right child, then the next greater key below (down) is found as indicated in block 1306 (see, e.g., FIG. 9b). Whether the next greater key is part of the same route is determined in block 1308. If the next greater key is not part of the same route, then, in block 1330, whether the temporary lower bound is equal to the segment lower bound (tempLB=S_LB) is tested. If the temporary lower bound is equal to the segment lower bound, then the process continues via connector E2 to block 1270 in FIG. 12d. If the temporary lower bound is not equal to the segment lower bound, then a retrace of the tree is performed as indicated in block 1332 because the tree might have changed due to previous deletes. The path stack is updated in the process of retracing (searching) the tree. After block 1332, the process continues via connector F1 to block 1340 in FIG. 13b, which will be discussed further below.

If the next greater key is part of the same route (tested in block 1308), then the key upper bound is set to the next greater key upper bound and a temporary lower bound is set to the key lower bound as indicated in block 1310. Thereafter, a key delete operation is performed in block 1312, deleting the next greater key and appropriately adjusting the associated data pointer. Additionally, the balance of the tree may be checked and adjusted in some embodiments. The process continues to block 1330 and continues thereafter as previously discussed.

If in block 1304 it is determined that the key does not have a right child, then whether the key is the last key in the node is tested in block 1314. If the key is the last key in the node, then a find next greater key above (up) is used as indicated in block 1316, in which the tree is iteratively climbed to find a next greater key by popping the path stack (see, e.g., FIG. 9a). Thereafter, whether the next greater key is found and is part of the same route as the matching key as indicated in block 1318. If the next greater key is part of the same route as the matching key, then a next greater key lower bound is set to the current key lower bound (NGK_LB=Key_LB), and a temporary lower bound is set to the key lower bound (temp_LB=Key_LB) as indicated in block 1320. Thereafter, a key delete operation is performed in block 1322, deleting the current (matching) key and adjusting the associated data pointer. Additionally, the balance of the tree may be checked as indicated in block 1322. The process continues to block 1330 and continues thereafter as previously discussed. If in block 1318 it is determined that the next greater key is not part of the same route as the matching key, then the process continues to block 1330 and continues thereafter as previously discussed

If in block 1314 it is determined that the matching key is not the last key in the node, then whether or not the right key is part of the route of the matching key is tested in block 1324. If the right key is part of the route of the matching key, then the block 1326 sets the matching key upper bound to the right key upper bound (Key_UB=RightKey_UB) and a temporary upper bound set to the right key upper bound (tempUB=RightKey_UB). Thereafter, a key delete operation is performed in block 1328, deleting the right key and adjusting the associated data pointer. Additionally, the balance of the tree may be checked. The process continues to block 1330 and continues thereafter as previously discussed.

Block 1340 in FIG. 13b may be reached if the right key is not part of the route of the matching key, as determined in block 1324, or through blocks 1330 and 1332 under a variety of other circumstances previously discussed. As indicated in block 1340, whether the matching key has a left child is tested. If the key has a left child, then a find next smaller key (down) process is used to iteratively follow the rightmost pointer of the left child to find the next smaller key as indicated in block 1342. Analogous processes to those described to find the next greater key may be used to find the next smaller key. Whether the next smaller key is part of the same route as the matching key is tested in block 1344. If the next smaller key is not part of the same route, then processing continues to block 1270 in FIG. 12d via connector E2 and continues thereafter as previously discussed. If the next smaller key is part of the same route, then the next smaller key upper bound is set to the key upper bound (NSK_UB=Key_UB) as indicated in block 1346. Thereafter, a key delete operation is performed in block 1348, deleting the matching key and adjusting the associated data pointer. Additionally, the balance of the tree may be checked in block 1348. The process continues to block 1270 of FIG. 12c via connector E2 and continues thereafter as previously discussed.

If in block 1340, it is determined that the key has no left child, then whether the matching key is in the first key in the node is tested in block 1350. If the matching key is in the first key in the node, then a find smaller key (up) process is used as indicated in block 1352. Whether the next smaller key is found and is part of the same route as the key is determined in block 1354. If not, then the process continues via connector E2 as previously discussed. If the next smaller key is part of the same route, then the next smaller key upper bound is set to the key upper bound as indicated in block 1356. A key delete process is then performed as indicated in block 1358.

If in block 1350 it is determined that the matching key is not the first key in the node, then whether the left key is part of the part of the route at issue is tested in block 1360. If the left key represents part of the route, then the left key upper bound is set to the matching key upper bound (LeftKey_UB=Key_UB) as indicated in block 1362. Thereafter, a key delete operation is performed in block 1364, deleting the matching key and adjusting the associated data pointer. Additionally, the balance of the tree may be checked as indicated in block 1364. The process continues to block 1270 of FIG. 12d via connector E2 and continues thereafter as previously discussed. If, in block 1360, it is determined that the left key is not part of the part of the route at issue, then the process continues directly to block 1270 of FIG. 12d via connector E2 and thereafter as previously discussed

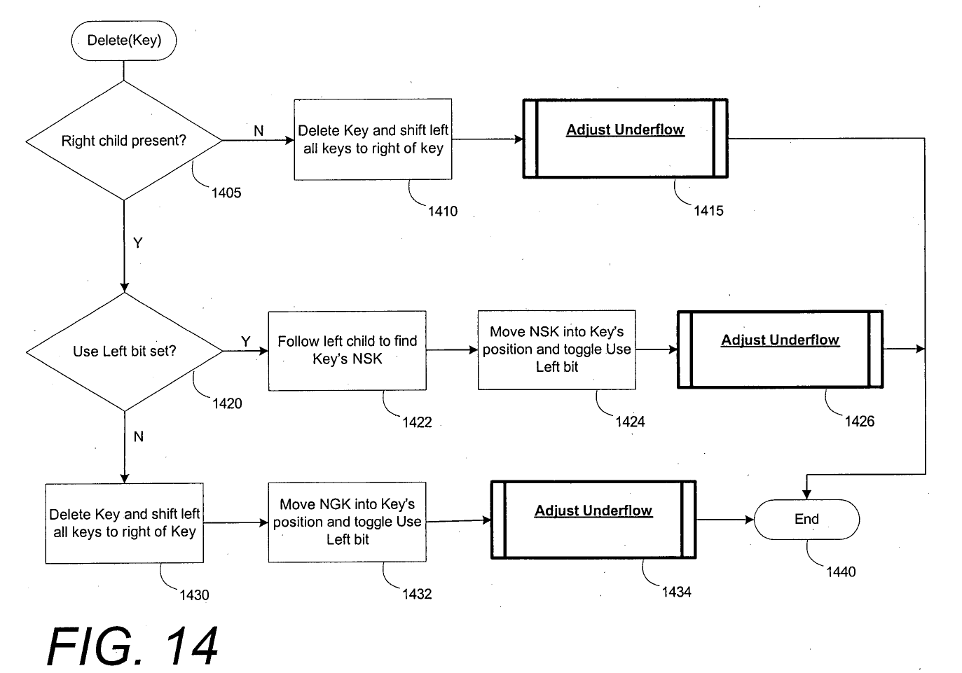

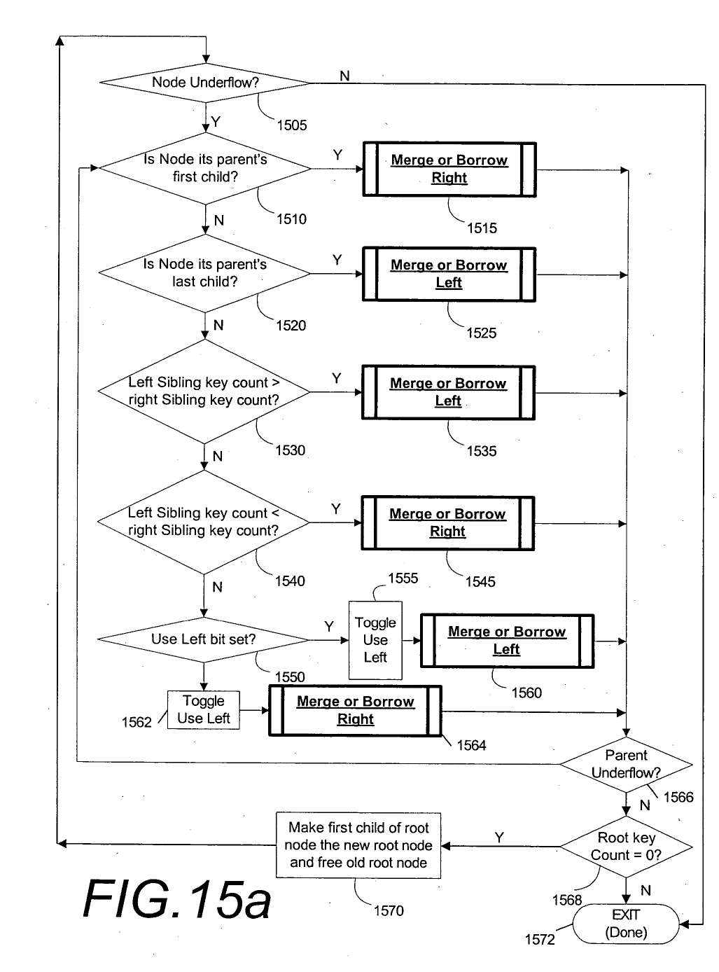

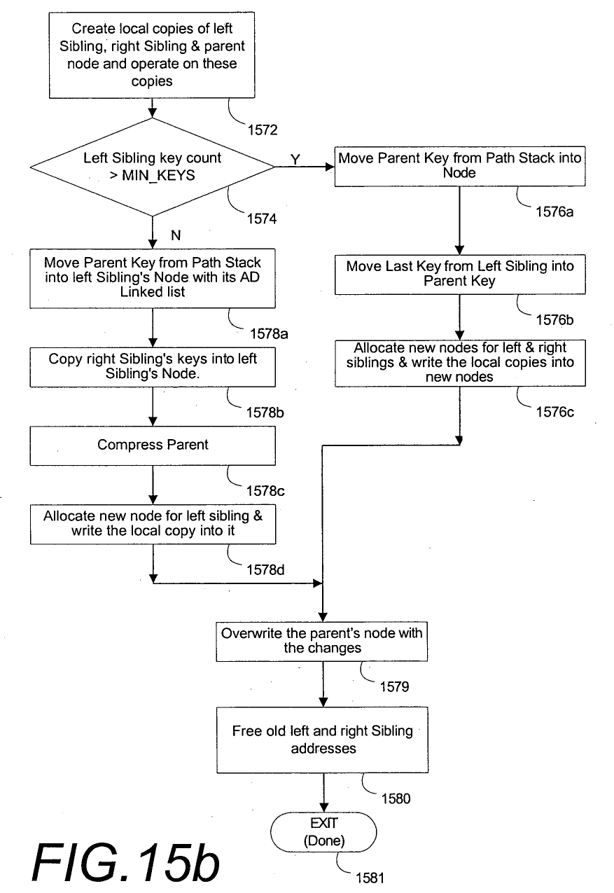

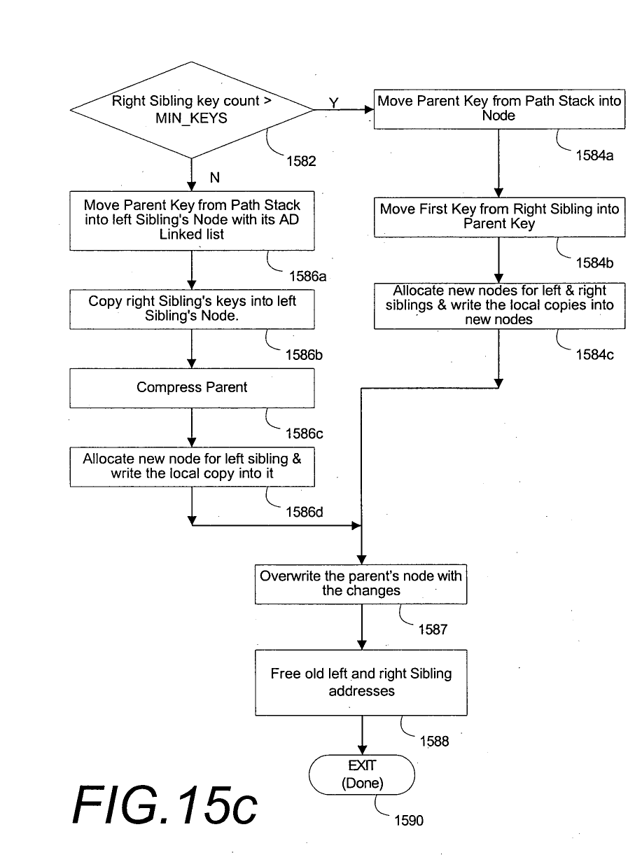

FIG. 14 illustrates a key delete procedure for one embodiment. The key delete procedure may be used to delete a key from the data structure, and may be called from a variety of points in the process of removing a route. In block 1405, whether the key to be deleted has a right child is tested. If the key to be deleted does not have a right child, then the key is deleted and all keys to its left are shifted to its right as indicated in block 1410. Thereafter, an adjust underflow process may be used (see, e.g., FIG. 15a) as indicated in block 1415. After the adjust underflow process, the key delete process completes in this case, as indicated in block 1440.

If, in block 1405, it is determined that the key to be deleted has a right child, then a “Use Left” bit is tested as indicated in block 1420. The Use Left bit is one way to balance to the tree. If Use Left is set, then the next smaller key is used to fill the created void. Therefore, if the Use Left bit is set, then the left child of the key to be deleted is followed to find the next smaller key as indicated in block 1422. Thereafter, the next smaller key is moved into the position occupied by the key to be deleted and the Use Left key is toggled as indicated in block 1424. Thereafter, the adjust underflow procedure may be used as indicated in block 1426, and then the delete process completes as indicated in block 1440.

If the Use Left bit is reset (as tested in block 1420), then the next greater key is used. Thus, as indicated in block 1430, the right child of the key to be deleted is followed to find the next greater key. The next greater key is moved into the position of the key to be deleted and the Use Left bit is toggled as indicated in block 1432. Once again, the adjust overflow process may be used, as indicated in block 1434, and then the delete process completes as indicated in block 1440.

In other embodiments, a more elaborate tree balance technique may be used than only toggling a single bit (e.g., the Use Left bit). In particular, one or more balance-tracking values can be updated based on both insert and delete operations, based on just insert operations, etc. Another alternative is for every operation on the tree to record its impact on the balance of the tree in one or more balance-tracking values. Alternatively, a balance-calculating process may scan the tree and determine if the tree is leaning to the left or leaning to the right, so to speak. Any such balance-determining may be used to bias the selection of left or right in block 1420 and/or other places.

FIG. 15a illustrates an adjust underflow process according to one embodiment. The adjust underflow process may be used, for example, by the key delete process of FIG. 14 (see, e.g., blocks 1415, 1426, and 1434), and prevents a node from having fewer than N/2 keys, where N is the maximum number of keys per node. As indicated in block 1505, whether node underflow occurs is tested. If no node underflow occurs (e.g., if the node has at least N/2 keys), then the adjust underflow process terminates as indicated in block 1572.

If, in block 1505, a node underflow does occur, then whether the node is the first child of its parent is tested in block 1510. If the node is the first child of its parent, then a merge or borrow right process (see, e.g., FIG. 15c) is used as indicated in block 1515. Thereafter, whether parent underflow now occurs is tested in block 1566. If parent underflow does occur, then the process returns to block 1510, et seq. If parent underflow does not occur, then whether the root node key count is zero is tested in block 1568. If the root node key count is not zero, then the process ends in block 1572. If the root node key count is determined to be zero in block 1568, then the first child of the root node is set to be the new root node and the old root node is freed as indicated in block 1570. Then, the adjust underflow process ends in block 1572.

If the node is determined not to be the first child of its parent in block 1510, then a whether the node is the last child of its parent is determined in block 1520. If the node is the last child of its parent, a merge or borrow left process (see, e.g., FIG. 15b) is used as indicated in block 1525. Thereafter, processing continues to block 1566 and the following blocks as previously discussed. If the node is determined not to be the last child of its parent in block 1520, then whether the left sibling key count is greater than the right sibling key count is determined in block 1530. If the left sibling key count is greater than the right sibling key count, then the merge or borrow left process is performed, as indicated in block 1525, and then processing continues with blocks 1566, et seq.

If the left sibling key count is not greater than the right sibling key count (as tested in block 1530), then whether the left sibling key count is less than the right sibling key count is tested in block 1540. If the left sibling key count is less, then a merge or borrow right process is used as indicated in block 1345, and processing continues via block 1566. If not, then whether the Use Left toggle bit is set is tested in block 1550. If Use Left is set, then the toggle bit is reset (toggled) in block 1555, the merge or borrow left process is used in block 1560, and then processing continues via block 1566. If the Use Left bit is reset, then the bit is set (toggled) in block 1562, the merge or borrow right process is used in block 1564, and then processing continues via block 1566. Thus, an node underflow may be remedied.

FIG. 15b details the merge or borrow left process according to one embodiment. The merge or borrow left process may be used, for example, from an adjust underflow procedure such as the embodiment of FIG. 15a to borrow a key from the node to the left of the underflow node or to merge a node with fewer than N/2 keys with other nodes. In the embodiment of the merge or borrow left process of FIG. 15b, in general, local copies of the left sibling, the right sibling, and the parent node of the underflow node are used to operate as indicated in block 1572. As indicated in block 1574, whether the left sibling key count is greater than the minimum key count (e.g., N/2) is tested. If the left sibling key count is greater than the minimum key count, then a key from the left sibling may be borrowed for the parent as described in blocks 1576a-1576c. The parent key is moved from the path stack into the node as indicated in block 1576a, and the last key from the left sibling is moved into the parent key as indicated in block 1576b. New nodes are allocated for the left and right siblings, and the local copies of the left and right siblings are written to the newly allocated nodes as indicated in block 1576c. The new left sibling has one less key at this point because it was moved up to the parent node. The parent node is overwritten with these changes, all as indicated in block 1579.

If the left sibling key count is determined not to be greater than the minimum key count in block 1574, then a merge operation may be performed as described in blocks 1578a-1578d. When a merge occurs, there are only two of three keys remaining, so there is no longer a right or left node. As indicated in block 1578a, the parent key is moved from the path stack into the left sibling node with its associated data linked list. The parent key is moved into the left node in this embodiment because the parent key is greater than the left node keys and therefore the parent key can be moved into the left node without shifting keys. Additionally, the right sibling keys are copied into the left sibling node to merge the parent and left sibling node as indicated in block 1578b. Since there were fewer than N/2 keys in both the left and the right node, there is room for both the left and the right node keys as well as one parent key. Therefore, the parent node is compressed to remove the key copied to the left sibling as indicated in block 1578c. A new node is allocated for the left and the local copy is written to the new node as indicated in block 1578d. Finally, the original parent node (not the temporary node) is overwritten with these changes, as also indicated in block 1579.

After block 1579, the old left and right sibling addresses may be freed as indicated in block 1580, and the process ends in block 1581. Thus, either a key has been borrowed from a left sibling or the siblings and a parent key have been merged by the merge or borrow left process. Notably, a parent underflow situation may be created by this process, but this situation may be handled by another iteration of the adjust underflow process.

FIG. 15c illustrates a merge or borrow right process according to one embodiment. The merge or borrow right process may be used, for example, from an adjust underflow procedure such as the embodiment of FIG. 15a to borrow a key from the node to the left of the underflow node or to merge a node with fewer than N/2 keys with another node. In the embodiment of the merge or borrow right process of FIG. 15c, in general, local copies of the left sibling, the right sibling, and the parent node of the underflow node are used to operate as was the case in the merge or borrow left process. As indicated in block 1582, whether the right sibling count is greater than the minimum number of keys is tested. If the right sibling count is greater than the minimum number of keys, then a key may be borrowed from the right node as described in blocks 1584a-1584c. First, the parent key is moved from the path stack into the (temporary) node as indicated in block 1584a. The first key from the right sibling is then copied into the parent key as indicated in block 1584b. New nodes are allocated for the left and right siblings and local copies are written into these new nodes as indicated in block 1584c. Finally, the parent node is overwritten with these changes, all as indicated in block 1587.

If the right sibling count is not greater than the minimum number of keys as tested in block 1582, then the right sibling node may be merged with the parent and the left sibling as described in blocks 1586a-1586d. Blocks 1586a-1586d merge the parent key with left and right siblings as discussed above with respect to blocks 1578a-1578d. The parent node is overwritten with these changes, all as indicated in block 1587. After block 1587, the old left and right sibling addresses are freed as indicated in block 1588, and the process ends in block 1590. Thus, either a key has been borrowed from a right sibling or a merge is performed by the merge or borrow right process.

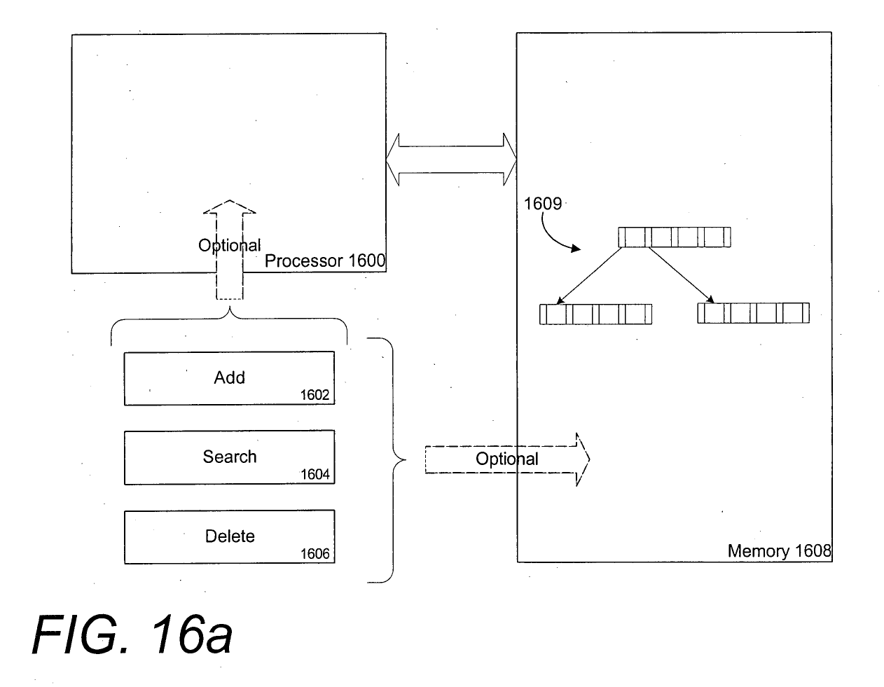

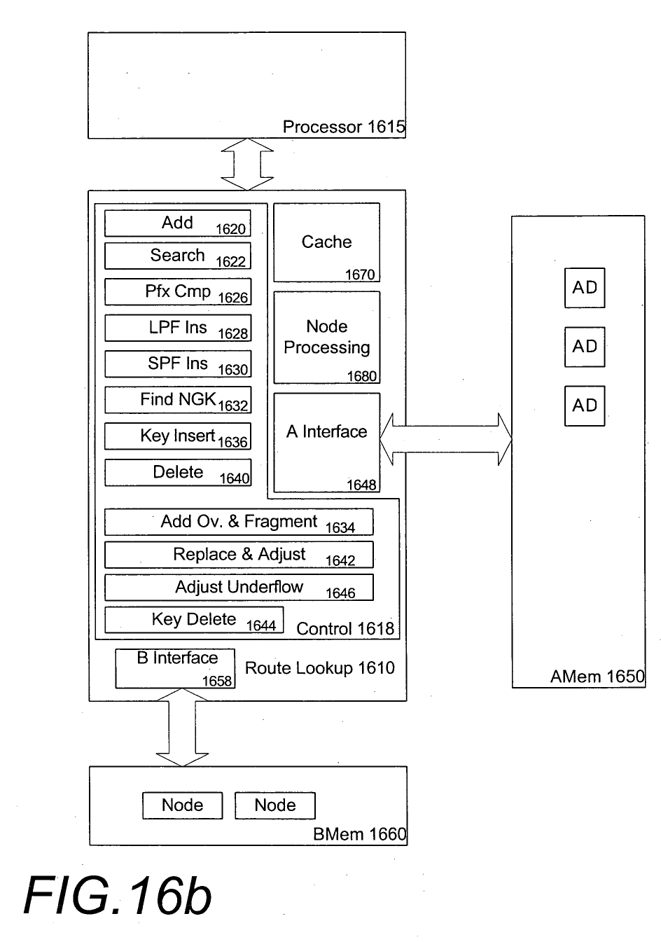

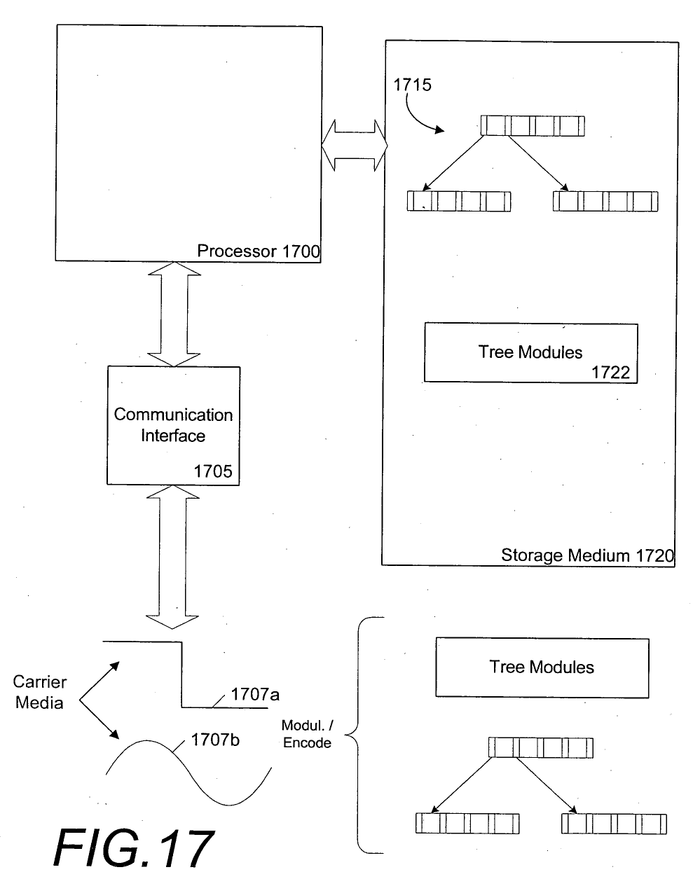

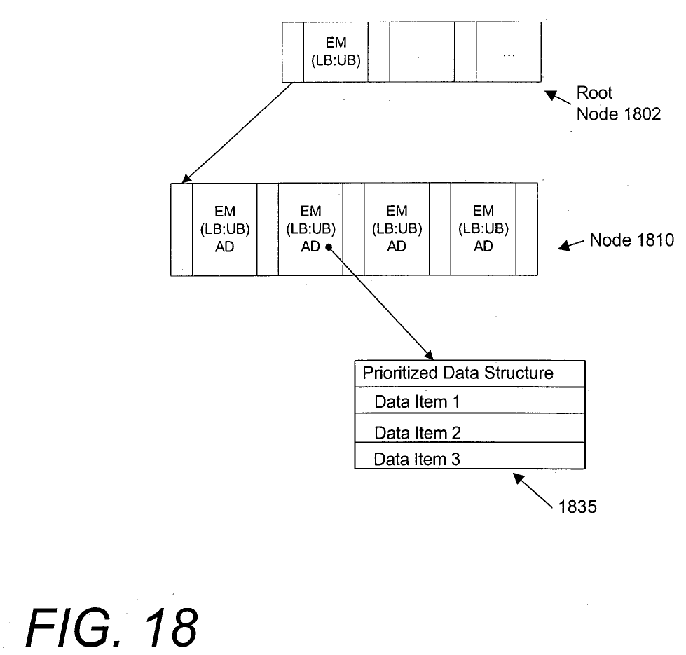

FIG. 16a illustrates one embodiment of a generalized system to build, use and maintain a tree with range-specifying keys to specify one a data items for a particular value or range of values. The embodiment of FIG. 16a includes a processor 1600 and a memory 1608. The memory stores a tree data structure 1609. In this embodiment, the system includes various modules to support tree usage. The modules may be logic, circuitry, microcode, software, a combination of execution logic and software, or any combination of these or other functionality-implementing techniques. Thus, in one embodiment, the required functionality may be built in to the processor 1600 in various forms, and in another embodiment, the modules may be software routines that are stored in memory and executed by the processor (e.g., see FIG. 17). In other embodiments, these modules may be implemented in system logic or split between some combination of one or more of the processor, software, and system logic. An add module 1602 is used to add new data items to the tree 1609. A search module 1604 is used to perform searches of the tree 1609, and a delete module 1606 is used to delete items from the tree 1609. These modules may have sub-modules to perform their respective functions, and may overlap. These modules may be implemented pursuant to one or more of the various processes described above. Various data item lookup applications may be implemented according to the generalized arrangement of FIG. 16a.

FIG. 16b illustrates one embodiment of an system to build, use and maintain a tree with range-specifying keys to specify routes for address lookup. In the embodiment of FIG. 16b, a route lookup device 1610 is coupled to and interacts with a main processor, processor 1615. In this embodiment, the route lookup device 1610 is a co-processor; however, in other embodiments, the disclosed techniques may be implemented by any processor, not just a co-processor. In one embodiment, the route lookup device 1610 may look up data for routes not found by the processor 1615. In other embodiments, the route lookup device 1610 may be a primary route lookup engine (e.g., it may be a processor such as a network processor). The system of FIG. 16b may be used in a routing application or a packet classification application, or both. For example, the system may be a part of a switch or a router.

As illustrated in FIG. 16b, the lookup device 1610 includes control logic 1618, a cache 1670 to cache node data and/or associated data, and node processing logic 1680. The lookup device 1610 is coupled to two memories, an associated data (A) memory 1650 and a B-Tree (B) memory 1660. In one embodiment, the associated data is stored in the A memory and the B-Tree nodes are stored in the B memory. In this embodiment, the A memory is accessed by an A memory interface 1648, and the B memory 1650 is accessed via a B interface 1658. However, different storage arrangements may be used in other embodiments.

The control logic 1618 generally provides functionality to build, use, and maintain a tree with range-specifying keys according to the techniques described herein. Thus, in some embodiments, the hardware may be used for other applications besides route lookup (i.e., any application where data values are associated with a range of input values as described with respect to the processes above). In one embodiment, the control logic includes various modules to implement the processes described. One of skill in the art will recognize that these processes may be implemented in a variety of manners, such as using microcode, state logic, dynamic logic, etc., or some combination thereof.

In one embodiment, the control logic 1618 includes a variety of modules. An add module 1620 adds new routes to the tree data structure. A search module 1622 searches the tree data structure given an input value. A prefix compare module 1626 compares two prefixes. A longer prefix fragment insert module 1628 inserts a route with a prefix longer than an existing route. A shorter prefix fragment insert module 1630 inserts a route with a prefix shorter than an existing route. A find next greater key module 1632 finds either a next greater key above or below a given point in the tree. An add overlap and fragment module 1634 adds a route broken into overlap and fragment segments. A key insert module 1636 inserts an identified key into the tree data structure. A delete module 1640 deletes a route from the tree data structure. A replace and adjust module 1642 helps perform de-fragmentation in conjunction with the delete module 1640. A key delete module 1644 deletes a specified key from the tree data structure, and finally an adjust underflow module 1646 adjusts underflow in a node after a key is deleted, and may also include merge or borrow left and right modules (not shown). Each of these modules may be implemented in a similar manner to the various process descriptions above. Notably, significant portions of hardware, software, and/or microcode may be overlapped between the various modules.

FIG. 17 illustrates an embodiment in which a set of software routines implement the various modules to build, use and maintain a tree data structure with range-specifying keys. The system shown in FIG. 17 includes a processor 1700, a storage medium 1720 coupled to the processor 1700 storing a set of modules 1722, and a communication interface 1705 coupled to the processor 1700. In this embodiment, the storage medium 1720 stores a data structure 1715 and tree modules 1722. The processor 1700 executes software routines that implement various modules to build, use and maintain a tree data structure in this embodiment. The modules 1722 may be the basic modules from FIG. 16a, the route-tree related modules from FIG. 16b, or some combination or subset of these modules.

The tree modules are software routines that might be resident on a system storage medium of a system device (e.g., a magnetic disk drive, an optical disk drive, one or more memory chips, etc.). The software modules may also be carried on a carrier medium as well. For example, a digital carrier medium 1707a or an analog carrier medium 1707b may transmit data containing the modules and/or the data structure.

Whether the modules are hardware or software, they may be represented by data in variety of manners. A hardware design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. In a software design, the design typically remains on a machine readable medium, but may also be transmitted as in the case of the carrier media 1707a and 1707b. An optical or electrical wave modulated or otherwise generated to transmit such information, a memory, or a magnetic or optical storage such as a disc may be the machine readable medium. Any of these mediums may “carry” the design or software information.

While an application for storing addresses in a tree data structure has been described, as previously noted, the disclosed techniques may be used in a variety of other applications. Generally, where a sorted list needs to be maintained and searched, the disclosed techniques may be used. Many database applications maintain and search ordered lists. For example, a list of names and some associated data may be maintained with a tree data structure as disclosed. A list of addresses, zip codes, phone numbers, identification numbers (e.g., personal identification numbers, device identification numbers), etc., may also be stored in a data structure as disclosed, in some cases being grouped into ranges and in some cases having multiple prioritized rules or data items associated therewith.

FIG. 18 illustrates one additional embodiment of a tree data structure. In the embodiment of FIG. 18, the tree includes a root node 1802 and a second node 1810 having exact match (EM) keys. An exact match key has a range of a single value. As shown in FIG. 18, an exact match key may use both range defining fields (e.g., lower bound and upper bound) to store an exact match value of greater length. In some embodiments, whether exact matches are used in a tree may be set globally for the entire tree. In other embodiments, a setting may be stored in a data field of the associated data for each entry indicating whether the two range-defining values are to be interpreted as defining a range or whether they should be used together to signify a single exact match value. The various processes described above, or somewhat simplified versions thereof, may be applied to a tree data structure such as the data structure of FIG. 18. Also shown in FIG. 18 is a prioritized data structure 1835 to store a prioritized set of data items associated with a key. As previously discussed, the prioritized data structure may be one of a variety of different types of data structures.

Thus, a tree data structure with range-specifying keys and associated methods is disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure.

What is claimed is:

1. A data structure comprising:
a root node, the root node including a number of sequential keys, each key including a first value and a second value, the first and second values of each key defining a range for that key, wherein the ranges of the number of key are non-overlapping; and
a pointer associated with the root node, the pointer identifying a child node, the child node having a range outside the range of each key in the root node.

2. The data structure of claim 1, wherein at least one of the keys of the root node further includes a data element.

3. The data structure of claim 1, wherein at least one of the keys of the root node further includes a pointer to an associated data element.

4. The data structure of claim 1, wherein the first value includes a lower bound of the range and the second value includes an upper bound of the range.

5. The data structure of claim 1, wherein one of the keys of the root node includes a pointer to a set of data elements.

6. The data structure of claim 5, wherein the set of data elements comprises a linked list.

7. The data structure of claim 5, wherein each data element of the set is associated with the range of the one key.

8. The data structure of claim 5, wherein one data element of the set is further associated with another one of the keys of the root node.

9. The data structure of claim 5, wherein the set of data elements is prioritized.

10. The data structure of claim 9, wherein a highest priority data element of the set of data elements corresponds to a data element having a longest length prefix.

11. The data structure of claim 1, further comprising a temporary node including a number of keys that is less than a minimum number of keys.

12. The data structure of claim 1, further comprising a temporary key, the temporary key having a range overlapping with the range of at least one of the keys in the root node.

13. The data structure of claim 1, wherein the range of the child node is between the ranges of two sequential keys.

14. The data structure of claim 1, wherein the range of the child node is beyond the range of an end key of the number of keys.

15. The data structure of claim 1, wherein the range of each of the keys corresponds to a range of network addresses.

16. The data structure of claim 1, wherein the root node and the child node comprise a B-Tree data structure.

17. The data structure of claim 1, wherein the data structure is capable of being stored in a machine readable medium.

18. The data structure of claim 1, wherein the machine readable medium comprises one of a memory device, a carrier wave, an optical storage device, and a magnetic storage device.

19. A method comprising:
storing in a memory a root node, the root node including a number of sequential keys, each key including a first value and a second value, the first and second values of each key defining a range for that key, wherein the ranges of the number of key are non-overlapping; and
storing in the memory a pointer associated with the root node, the pointer identifying a child node, the child node having a range outside the range of each key in the root node.

20. The method of claim 19, wherein at least one of the keys of the root node further includes a data element.

21. The method of claim 19, wherein at least one of the keys of the root node further includes a pointer to an associated data element.

22. The method of claim 19, wherein the first value includes a lower bound of the range and the second value includes an upper bound of the range.

23. The method of claim 19, wherein one of the keys of the root node includes a pointer to a set of data elements.

24. The method of claim 23, wherein the set of data elements comprises a linked list.

25. The method of claim 23, wherein each data element of the set is associated with the range of the one key.

26. The method of claim 23, wherein one data element of the set is further associated with another one of the keys of the root node.

27. The method of claim 23, wherein the set of data elements is prioritized.

28. The method of claim 27, wherein a highest priority data element of the set of data elements corresponds to a data element having a longest length prefix.

29. The method of claim 19, further comprising storing in the memory a temporary node including a number of keys that is less than a minimum number of keys.

30. The method of claim 19, further comprising storing in the memory a temporary key, the temporary key having a range overlapping with the range of at least one of the keys in the root node.

31. The method of claim 19, wherein the range of the child node is between the ranges of two sequential keys.

32. The method of claim 19, wherein the range of the child node is beyond the range of an end key of the number of keys.

33. The method of claim 19, wherein the number of sequential keys are stored in contiguous memory locations of the memory.

34. An apparatus comprising:
a memory having a data structure stored therein, the data structure including
a root node, the root node including a number of sequential keys, each key including a first value and a second value, the first and second values of each key defining a range for that key, wherein the ranges of the number of key are non-overlapping, and
a pointer associated with the root node, the pointer identifying a child node, the child node having a range outside the range of each key in the root node.

35. The apparatus of claim 34, wherein at least one of the keys of the root node further includes a data element.

36. The apparatus of claim 34, wherein at least one of the keys of the root node further includes a pointer to an associated data element.

37. The apparatus of claim 34, wherein the first value includes a lower bound of the range and the second value includes an upper bound of the range.

38. The apparatus of claim 34, wherein one of the keys of the root node includes a pointer to a set of data elements.

39. The apparatus of claim 38, wherein the set of data elements comprises a linked list.

40. The apparatus of claim 38, wherein each data element of the set is associated with the range of the one key.

41. The apparatus of claim 38, wherein one data element of the set is further associated with another one of the keys of the root node.

42. The apparatus of claim 38, wherein the set of data elements is prioritized.

43. The apparatus of claim 42, wherein a highest priority data element of the set of data elements corresponds to a data element having a longest length prefix.

44. The apparatus of claim 34, further comprising a temporary node stored in the memory, the temporary node including a number of keys that is less than a minimum number of keys.

45. The apparatus of claim 34, further comprising a temporary key stored in the memory, the temporary key having a range overlapping with the range of at least one of the keys in the root node.

46. The apparatus of claim 34, wherein the range of the child node is between the ranges of two sequential keys.

47. The apparatus of claim 34, wherein the range of the child node is beyond the range of an end key of the number of keys.

48. The apparatus of claim 34, further comprising a processing device coupled with the memory.

49. The apparatus of claim 48, wherein the processing device includes logic to generate the data structure.

50. The apparatus of claim 48, further comprising a set of instructions stored in the memory that, when executed on the processing device, generate the data structure in the memory.

51. The apparatus of claim 48, wherein the processing device includes a set of instructions stored thereon that, when executed on the processing device, generate the data structure in the memory.

52. An article of manufacture comprising:
a machine accessible medium providing content that, when accessed by a machine, causes the machine to
store in a memory a root node, the root node including a number of sequential keys, each key including a first value and a second value, the first and second values of each key defining a range for that key, wherein the ranges of the number of key are non-overlapping; and
store in the memory a pointer associated with the root node, the pointer identifying a child node, the child node having a range outside the range of each key in the root node.

53. The article of manufacture of claim 52, wherein at least one of the keys of the root node further includes a data element.

54. The article of manufacture of claim 52, wherein at least one of the keys of the root node further includes a pointer to an associated data element.

55. The article of manufacture of claim 52, wherein the first value includes a lower bound of the range and the second value includes an upper bound of the range.

56. The article of manufacture of claim 52, wherein one of the keys of the root node includes a pointer to a set of data elements.

57. The article of manufacture of claim 56, wherein the set of data elements comprises a linked list.

58. The article of manufacture of claim 56, wherein each data element of the set is associated with the range of the one key.

59. The article of manufacture of claim 56, wherein one data element of the set is further associated with another one of the keys of the root node.

60. The article of manufacture of claim 56, wherein the set of data elements is prioritized.

61. The article of manufacture of claim 60, wherein a highest priority data element of the set of data elements corresponds to a data element having a longest length prefix.

62. The article of manufacture of claim 52, wherein the content, when accessed, further causes the machine to store in the memory a temporary node including a number of keys that is less than a minimum number of keys.

63. The article of manufacture claim 52, wherein the content, when accessed, further causes the machine to store in the memory a temporary key, the temporary key having a range overlapping with the range of at least one of the keys in the root node.

64. The article of manufacture of claim 52, wherein the range of the child node is between the ranges of two sequential keys.

65. The article of manufacture of claim 52, wherein the range of the child node is beyond the range of an end key of the number of keys.

66. The article of manufacture of claim 52, wherein the number of sequential keys are stored in contiguous memory locations of the memory.
